(19) United States
(12) Patent Application Publication
(10) Pub. No.: US 2022/0412117 A1
(43) Pub. Date: Dec. 29, 2022

(54) SCALABLE AND PORTABLE MULTIPURPOSE WORKSITE SYSTEM

(71) Applicant: Geng Yan, Calgary (CA)

(72) Inventor: Geng Yan, Calgary (CA)

(21) Appl. No.: 17/901,797

(22) Filed: Sep. 1, 2021

Related U.S. Application Data
(63) Continuation-in-part of application No. 17/811,861, filed on Jul. 11, 2022.

(51) Int. Cl. E04H 15/14; E04H 15/46; E04H 15/64; F24F 8/108; F24F 7/013; F24F 13/20; F16B 2/22; F16B 2/10

(52) U.S. Cl. CPC E04H 15/14; E04H 15/46; E04H 15/64; F24F 8/108; F24F 7/013; F24F 13/20; F16B 2/22; F16B 2/10; F24F 2221/12

(57) ABSTRACT

The invention comprises a scalable and foldable multipurpose frame structure configured with a generally flat-roof as a worksite and a peaked-roof as a recreational canopy, a cover retaining system and a ventilation system. The frame structure comprises a plurality of foldable wall trusses connecting a plurality of upright telescopic posts transversely forming a wall frame structure and a closed loop geometric footprint, a plurality of foldable roof trusses connecting a centrally disposed roof assembly to either the telescopic posts or the wall trusses transversely forming the roof. The cover retaining system comprises various spring clips for known-size frame members, and various clamps for unknown-size frame members, to secure roof and wall cover to the frame structure. The ventilation system comprises an enclosure that can utilize standard furnace air filters and existing air circulation devices. Multiple frame structures can be linked together to scale up space.

### FIELD OF THE INVENTION

The present invention relates to a scalable and portable multipurpose worksite system that can provide workspace isolation or separation from the surrounding elements, and can be transformed to serve recreational purpose. The present invention offers a frame structure that can be quickly set up and dismantled, adjusted in height to accommodate height constrains, scaled up with multiple units, converted between work and recreational usages, and stowed away in compact and space-saving form. The present invention also provides a ventilation system that can utilize existing air circulation devices, and a cover retaining system than can firmly secure commercially available plastic sheeting to the frame structure to form the cover for worksite purpose.

### BACKGROUND OF THE INVENTION

In many worksites such as construction and renovation sites, it's inevitable that work activities generate airborne particles, such as saw dust, tile cutting dust, sanding dust, spray painting droplets, etc. The airborne nature of the particles creates difficulties to perform concurrent work activities and work waste cleanup, due to hard-to-control cross-contamination. For example, saw dust and tile cutting dust may contaminate un-dried painting surfaces and create difficulty to clean up, while spray painting droplets may contaminate existing finished surfaces. This creates the need for a temporary workspace, in which work waste is contained within the workspace, to prevent cross-contamination to surrounding elements. In other situations, there are needs to protect elements from surrounding airborne particles, such as protecting tools, furniture, un-dried painted parts, etc., from being contaminated by dusts or droplets.

To fulfill the pollution isolation role of the worksite, it demands the ability to utilize commercially available plastic sheeting and other readily available sheeting materials as covering, so that the contaminated covering can be responsibly disposed of; It also demands the ability to provide ventilation in the enclosed workspace when ventilation is entailed. This requires a cover retaining system that can reliably and firmly secure the covering to the temporary worksite structure, and a ventilation system that can utilize existing devices readily available to a user.

Due to the temporary nature of a portable worksite, when the worksite is not needed, this asset becomes idle and seldom can find other usages. This is especially an issue for homeowners who do the work themselves. Therefore, there is also a strong need for a multipurpose worksite system, that can be converted between work and recreational usages, so as to increase the asset utilization and cost-effectiveness of the ownership.

While there are other portable worksites existing in the art, for example, patent Pub. No. US 2020/0230638 A1 and US 210/0272915 A1, they are limited in the functions of quick and easy assembling/dissembling, and/or compact storage. Due to the temporary nature of a portable worksite, these create their limits. They are also limited in other factors demanded by a temporary worksite, specifically, in the scalability, where larger space is required, and/or the adjustability, where the worksite height must be adjusted to accommodate its external housing constrains.

There are many other portable frame structures existing in prior art in other fields, such as U.S. Pat. Nos. 9,482,026 B2, 7,520,290 B2, and 10,80,249 B2. However, they serve respective objectives in their fields but not for the scalable and portable multipurpose worksite objectives.

Many clamping devices exist in prior art in other fields, such as U.S. Pat. Nos. 8,006,711 B2, 5,441,307 and 4,381,585. They all provide a firm grip to tubular materials which are also commonly used as framing members of frame structures; however, they cannot provide the ability to secure thin sheeting to a frame structure without breaking it. Many existing commercially available spring clamps can also be utilized to temporarily attach sheeting to a frame structure; however, they are not designed to provide strong and firm grip for thin materials to be clamped on various commonly utilized frame structure materials, which lead to loose contacts due to that they only provide insufficient points or lines of contacts on the surfaces of the materials they are clamped on.

Therefore, there is a strong need for a portable worksite system that can be quickly assembled and dissembled, can be easily adjusted in height, can be scaled up with multiple units, can utilize commercially available sheeting as disposable covering, can provide additional ventilation via existing means, and can be converted for recreational use or stowed away in compact form when the worksite is not needed.

### SUMMARY OF THE INVENTION

The primary object of the present invention is to provide a foldable worksite frame structure that can be quickly and easily assembled and dissembled, and in compact storage form.

The second object is to provide recreational usage when the foldable worksite frame structure is not needed for work purpose.

The other object is to provide capacity of height adjustment when setting up the frame structure, so that the frame structure's height can be adjusted to accommodate its exterior housing constrains, such as a ceiling limit imposed by a garage or a room in which the frame structure is being setup.

The other object is to provide capacity to scale up the workspace or recreational space by linking multiple units of the frame structure.

The other object is to provide a ventilation system that can utilize a commercial standard furnace air filter to filter airborne particles or droplets, and force air circulation inside the worksite by an existing air circulation device such as a blower fan, or through ducting to other ventilation devices, or by customization to utilize an existing bathroom exhaust fan and so on.

The other object is to provide a roof and wall cover retaining system that can securely attach existing commercially available plastic sheeting and/or other fabrics to the frame structure, so as to cover the roof and walls to form an isolated workspace.

The other object is to provide a universal roof and wall cover retaining system that can securely attach existing commercially available plastic sheeting and/or other fabrics to an existing frame structure that a user has already owned, so as to cover the roof and walls to form an isolated workspace.

To the accomplishment of the above and related objects, this invention may be embodied in the preferred embodiments illustrated in the accompanying drawings. It should be noted however, that the drawings are illustrative only, and that various embodiments can be made to achieve the same objectives.

### DESCRIPTION OF DRAWINGS

Various other objects, features and advantages of the present invention will become fully appreciated and better understood when considered in conjunction with the accompanying drawings, wherein for the preferred embodiments:

FIG. 1 is a perspective view of a frame structure in worksite configuration, which has a generally flat roof in the first preferred embodiment.

FIG. 2 is a perspective view of the frame structure of FIG. 1 converted to a recreational configuration, which has a peaked roof.

FIG. 3 is a perspective view of two linked frame structures of FIG. 1 for worksite scaling-up illustration.

FIG. 4 is a perspective view of two linked frame structures of FIG. 2 for recreational space scaling-up illustration.

FIG. 5 is a perspective view of the frame structure of FIG. 1 in a folded position when the worksite is not needed and to be stowed.

FIG. 6 is an exploded view of a frame linkage assembly that may be used to connect two frame structures and form a scaleup site.

FIG. 7 is an exploded view of a telescopic post that may be used on the frame structure of FIG. 1.

FIG. 8 is a perspective view of the telescopic post of FIG. 7.

FIG. 9 is a perspective view of the telescopic post from the opposite direction of FIG. 8.

FIG. 10 is a combination of orthographic, sectional and perspective views of a post cap bracket that may be used on the telescopic post of FIG. 7.

FIG. 11 is an exploded view of a post slider bracket that may be used on the telescopic post of FIG. 7.

FIG. 12 is a combination of orthographic, sectional and perspective views of the post slider bracket of FIG. 11.

FIG. 13 is an exploded view of a height adjustor that may be used on the telescopic post of FIG. 7.

FIG. 14 is a combination of orthographic, sectional and perspective views of the height adjustor of FIG. 13.

FIG. 15 is an exploded view of a roof assembly consisting of a roof peak assembly and a roof connector assembly that may be used in FIG. 2 recreational configuration.

FIG. 16 is a combination of orthographic, sectional and perspective views of the roof assembly of FIG. 15.

FIG. 17 is a perspective view of a foldable wall truss that may be used on the frame structure of FIG. 1.

FIG. 18 is a perspective view of a foldable roof truss that may be used on the frame structure of FIG. 1.

FIG. 19 is a perspective view of a roof cap that may be used on the roof assembly of FIG. 15.

FIG. 20 is a perspective view of a roof connector that may be used on the roof assembly of FIG. 15.

FIG. 21 is a perspective view of a slidable connector that may be used on the roof assembly of FIG. 15.

FIG. 22 is a perspective view of a position limit flange that may be used on the roof assembly of FIG. 15.

FIG. 23 is a perspective view of a roof peak pole that may be used on the roof assembly of FIG. 15.

FIG. 24 is a perspective view of a roof pole that may be used on the roof assembly of FIG. 15.

FIG. 25 is a perspective view of a longitudinal member that may be used on the wall truss of FIG. 17.

FIG. 26 is a perspective view of a fastener that may be used on various components.

FIG. 27 is a perspective view of a rotation limit connector that may be used on the roof truss of FIG. 18.

FIG. 28 is a perspective view of a first longitudinal member that may be used on the roof truss of FIG. 18.

FIG. 29 is a perspective view of a second longitudinal member that may be used on the roof truss of FIG. 18.

FIG. 30 is a perspective view of a frame structure in worksite configuration in the second preferred embodiment.

FIG. 31 is a perspective view of the frame structure in recreational configuration in the second preferred embodiment.

FIG. 32 is a perspective view of the connections between a second type roof truss and a second type wall truss that may be used in the second preferred embodiment.

FIG. 33 is a perspective view of a first T connector that may be used in the second preferred embodiment.

FIG. 34 is a perspective view of a second T connector that may be used in the second preferred embodiment.

FIG. 35 is a combination of perspective views of a second type post cap bracket that may be used in the second preferred embodiment.

FIG. 36 is a combination of perspective views of a second type post slider bracket that may be used in the second preferred embodiment.

FIG. 37 is an exploded view of a ventilation assembly.

FIG. 38 is a front perspective view of the ventilation assembly of FIG. 37 connected to an inner post of the telescopic post of FIG. 7.

FIG. 39 is an exploded view of a ventilation connector assembly.

FIG. 40 is a rear perspective view of the ventilation assembly of FIG. 38.

FIG. 41 is a rear perspective view that shows a blower fan is installed inside the ventilation assembly of FIG. 38.

FIG. 42 is a rear perspective view that shows a bathroom exhaust fan is installed in conjunction with the ventilation assembly of FIG. 38.

FIG. 43 is a perspective view of a spring clip that may be used to secure a cover to the wall trusses of FIG. 17 and FIG. 32.

FIG. 44 is an illustrative view that shows how the spring clip of FIG. 43 is clamped on a short section of a wall truss longitudinal member.

FIG. 45 is an illustrative view that shows how the cross-sectional shape of the spring clip of FIG. 43 changes from free form to clamped-on form.

FIG. 46 is a perspective view of a spring clip that may be used to secure a cover to the telescopic post of FIG. 7.

FIG. 47 is an illustrative view that shows how the spring clip of FIG. 46 is clamped on a short section of a telescopic post tubular member.

FIG. 48 is an illustrative view that shows how the cross-sectional shape of the spring clip of FIG. 46 changes from free form to clamped-on form.

FIG. 49 is a perspective view of a spring clip that may be used to secure a cover to the telescopic post of FIG. 7.

FIG. 50 is an illustrative view that shows how the spring clip of FIG. 49 is clamped on a short section of a telescopic post tubular member.

FIG. 51 is an illustrative view that shows how the cross-sectional shape of the spring clip of FIG. 49 changes from free form to clamped-on form.

FIG. 52 is a perspective view of a spring clip that may be used to secure a cover to a cylindrical member of a frame structure if cylindrical members are employed.

FIG. 53 is an illustrative view that shows how the spring clip of FIG. 52 is clamped on a short section of a cylindrical member.

FIG. 54 is an illustrative view that shows how the cross-sectional shape of the spring clip of FIG. 52 change from free form to clamped-on form.

FIG. 55 shows a fragmentary illustration of a cover made of clear plastic sheeting is secured by a plurality of spring clips of FIG. 43 to a wall truss of FIG. 17.

FIG. 56 is a fragmentary illustration that shows a wall cover made of clear plastic sheeting is secured to a telescopic post of FIG. 7 via a spring clip of FIG. 46.

FIG. 57 is a perspective view of a universal spring clamp for frame members having elongated cross-sections.

FIG. 58 is an illustrative view that shows how the spring clamp of FIG. 57 is clamped on a short section of a frame member having an elongated cross-section.

FIG. 59 is an exploded view of the spring clamp of FIG. 57.

FIG. 60 is a perspective view of a universal spring clamp for frame members having various non-elongated cross-sections.

FIG. 61 is an exploded view of the spring clamp of FIG. 60.

FIG. 62 is an exploded view of a universal locking clamp.

FIG. 63 is a perspective view of the locking clamp of FIG. 62.

FIG. 64 is a perspective view of a swivel nut that may be used on the locking clamp of FIG. 62.

FIG. 65 is a longitudinal projection view of an actuator that may be used on the locking clamp of FIG. 62.

FIG. 66 is a combination of orthographic, sectional and perspective views of the locking clamp of FIG. 62.

FIG. 67-68 are illustrative views that show how the positions of the actuator of FIG. 65 affect the opening gap of the locking clamp of FIG. 62.

FIG. 69-71 are illustrative views that show how the locking clamp of FIG. 62. accommodates various cross-sectional shapes of the frame structure members.

FIG. 72 is a perspective view of a universal locking clamp in another embodiment.

FIG. 73 is a perspective view of a universal locking clamp in another embodiment.

FIG. 74 is an illustrative view that shows a fully configured worksite covered with clear plastic sheeting in the first preferred embodiment.

FIG. 75 is an illustrative view that shows the frame structure in recreational configuration covered with a peaked roof cover.

FIG. 76 is an illustrative view that shows two identical frame structures in recreational configuration linked together for recreational space scaling-up.

### DETAILED DESCRIPTION OF THE INVENTION

Described below are the preferred embodiments of the present invention, which illustrate ways in which the invention may be implemented. Although the embodiments shown are described in the context of worksite, the invention can also be used for other purposes such as storage and recreation. In the descriptions that follow, the first preferred embodiment is disclosed in details to illustrate the principles of the invention. Other preferred embodiments are also disclosed as illustrations of how the principles can be embodied in different forms. Therefore, it should be noted that the preferred embodiments are merely respective forms of the many potential embodiments, and the structural and functional details described herein are not intended to be limiting of the invention, but merely serve as the exemplary representations and the principles of the present invention.

In the disclosure the same reference characters represent the same elements in all figures. The references of “up”, “down”, “upper”, “lower”, “top”, “bottom”, “vertical”, “horizontal”, “front”, “rear” and so on are based on the positions shown on the views. Terms like “first”, “second”, “third”, “forth”, “last”, “one”, “another”, “on one end”, “on the other end” and so on are used to arbitrarily distinguish the elements in relation to the position and/or the sequence of a description or illustration. On the figures with a combination of orthographic, cross-sectional and perspective views, the reference characters may not be indicated to avoid reducing legibility of the drawing details, however the components will become obvious on the other views. Connecting parts such as nuts, bolts and screws are generally referred to as fasteners.

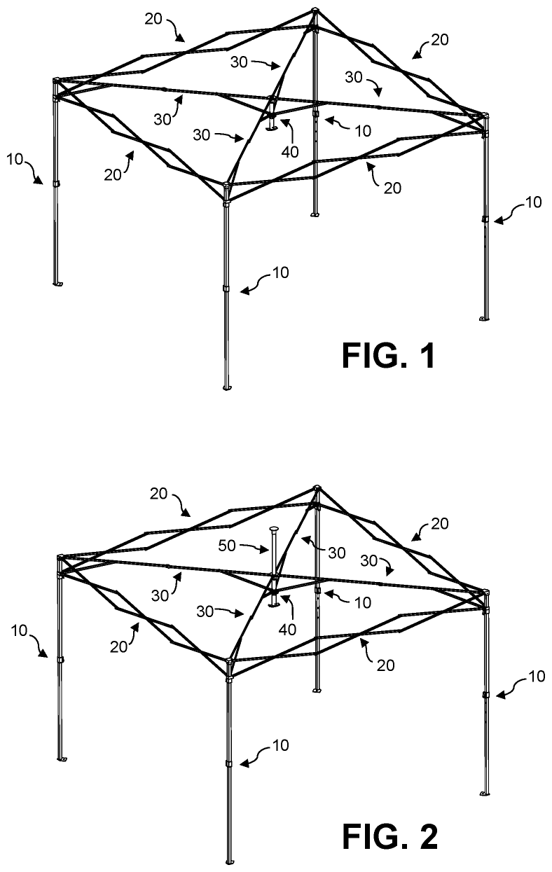

FIG. 1 illustrates a scalable and portable popup frame structure (referred to as a frame structure hereon) configured as a worksite in its deployed position in the first preferred embodiment. The frame structure may comprise a plurality of telescopic posts 10 vertically standing on the ground, a plurality of foldable wall trusses 20 transversely connecting the adjacent telescopic posts 10 to form a closed loop wall frame structure, a centrally disposed roof connector assembly 40, and a plurality of foldable roof trusses 30 transversely connecting the telescopic posts 10 and the roof connector assembly 40 to form a roof characterized as a generally flat roof. The outermost surfaces of the closed loop wall frame structure define a geometric footprint of the frame structure and the telescopic posts 10 define the vertices of the geometric footprint.

FIG. 2 illustrates the frame structure configured as a recreational canopy in its deployed position in the first preferred embodiment. A roof peak assembly 50 is mounted to the top of the roof connector assembly 40 to form a peaked roof.

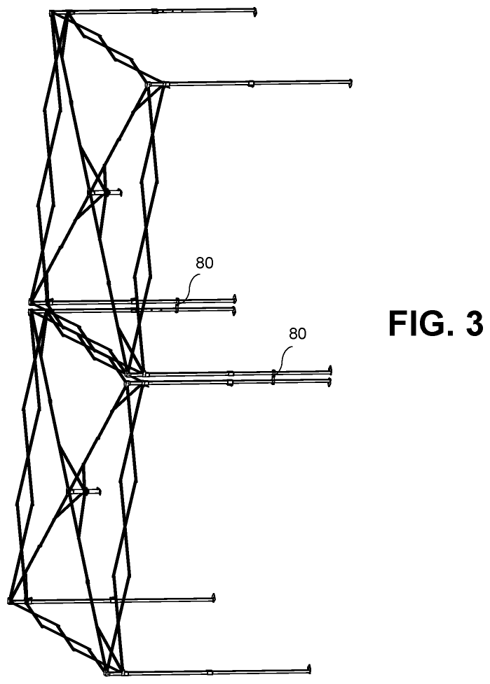

FIG. 3 illustrates two identical frame structures in worksite configuration may be linked together by frame linkage assemblies 80. A user may scale up workspace by linking multiple identical units.

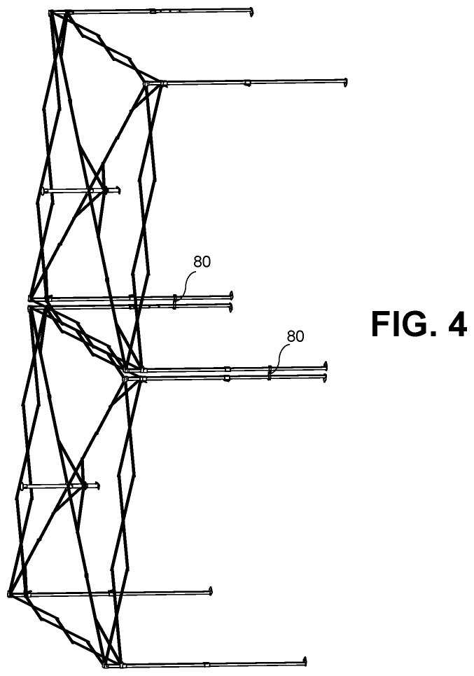

FIG. 4 illustrates two identical frame structures in recreational configuration may be linked together by frame linkage assemblies 80. A user may scale up recreational space by linking multiple identical units.

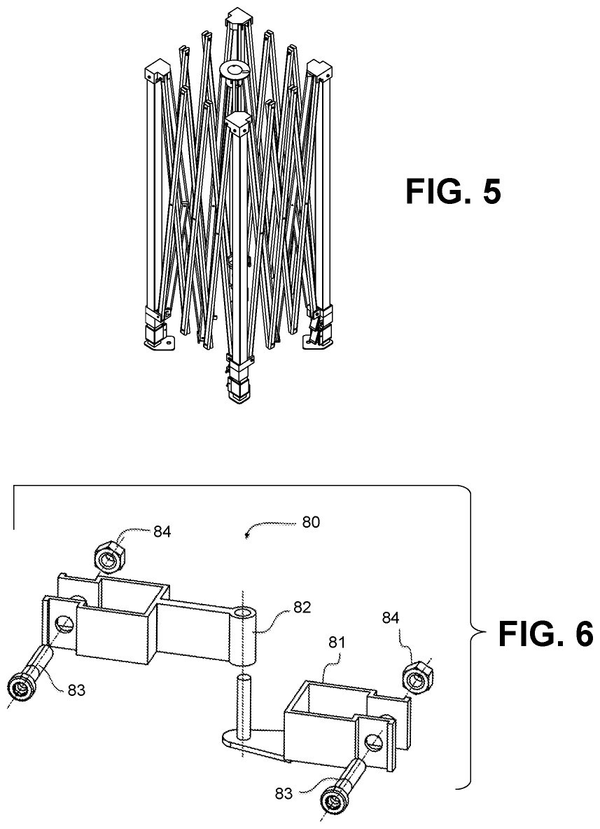

FIG. 5 illustrates the frame structure in a folded and retracted position in the first preferred embodiment. The telescopic posts 10 are retracted and the roof trusses 30 and wall trusses 20 are folded and bunched. The frame structure may be collapsed and folded into compact size for storage and transportation without any tools.

FIG. 6 illustrates how the frame linkage assembly 80 may be put together in the preferred embodiments. The frame linkage assembly 80 may comprise a bracket 81 and a coupling bracket 82. The bracket 81 may comprise a body having a bracket end sized and shaped to be clamped on the telescopic post 10 and a hinge end having a vertical hinge, whereof the hinge end and the bracket end may be connected by a horizontal plate so that the hinge end is extended horizontally away from the bracket end. The bracket 81 may be clamped on a telescopic post 10 from one frame structure by fasteners 83 and 84 on the bracket end. The bracket 82 may comprise a bracket end similar to the connector 81, and a hinge seat end having a vertical hollow cylinder, whereof the hinge seat end and the bracket end may be connected by a vertical plate so that the hinge seat end is extended horizontally away from the bracket end. The bracket 82 may be clamped on an adjacent telescopic post 10 from another identical frame structure in the same way as the bracket 81. The hinge of the bracket 81 may be inserted into the hollow cylinder of the bracket 82 to secure two adjacent telescopic posts 10 from two different units. Two sets of frame linkage assemblies 80 may be used to fully secure two identical units and combine them into one larger space.

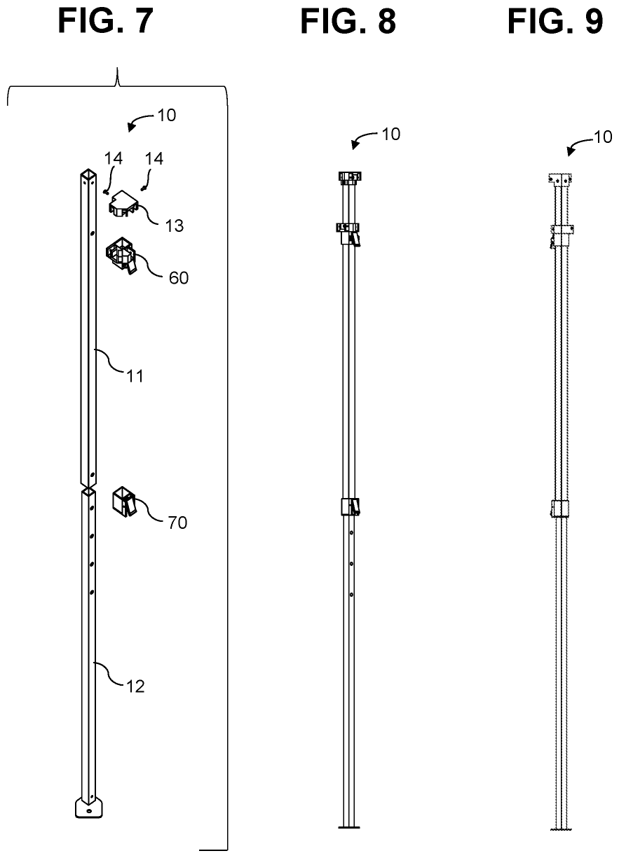

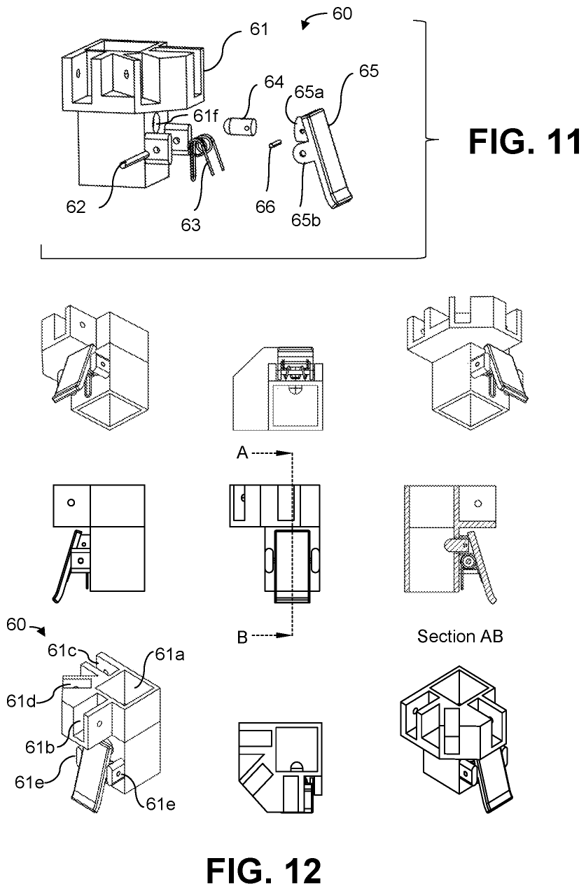

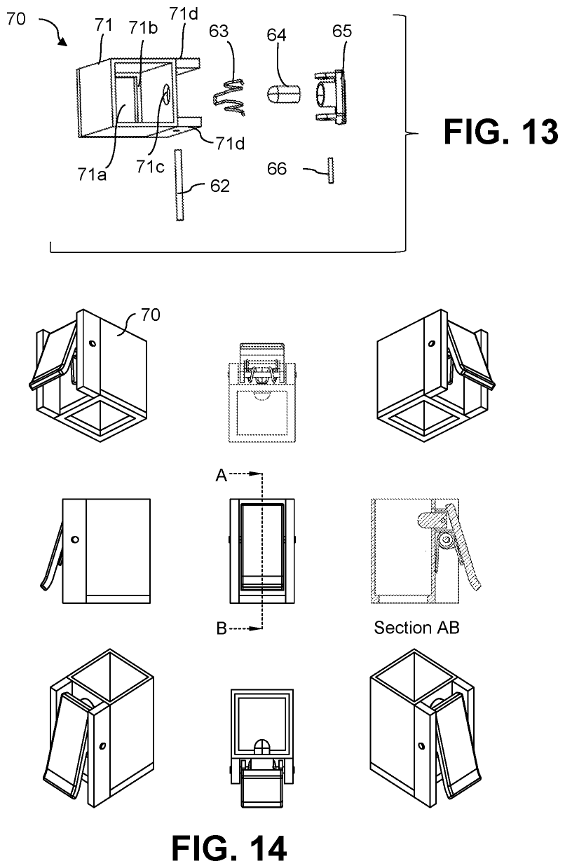

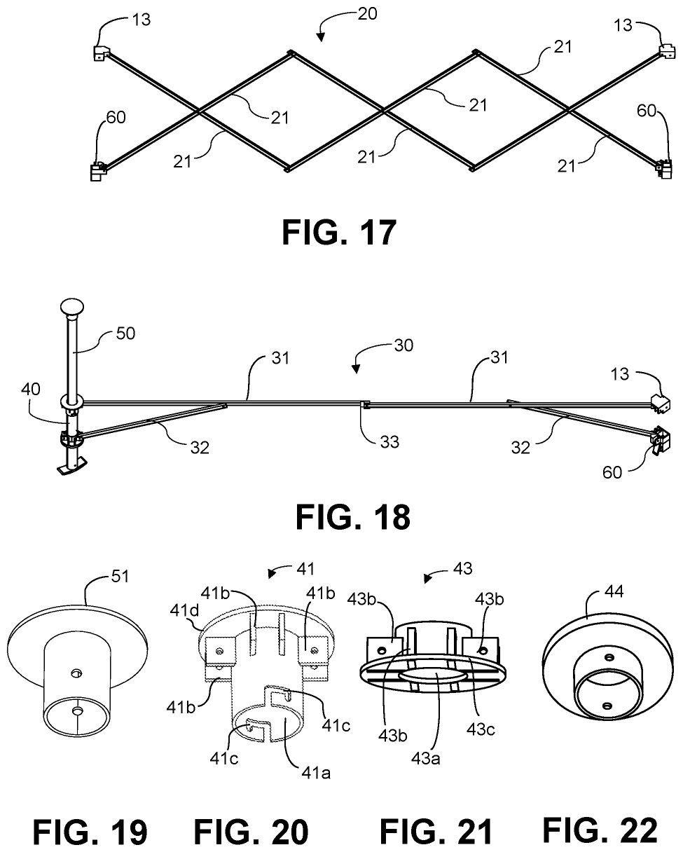

FIG. 7 illustrates how the telescopic post 10 may be put together in the first preferred embodiment. The telescopic post 10 may comprise a post cap bracket 13, a post slider bracket 60, a height adjustor 70, a tubular outer post 11, and a tubular inner post 12. The tubular inner post 12 is sized and shaped to be slidably received into the tubular outer post 11 and may have a plurality of position pin holes on the upper body, thereof the telescopic post may be axially extended and retracted. The outer post 11 may contain an upper position pin hole on the upper body to receive the lock pin 64 from the post slider bracket 60 (FIG. 11), so as to lock the post slider bracket 60 in its upper position limit. The outer post 11 may further contain a lower position pin hole at the bottom of the body, to axially align with the pin hole 71c on the height adjustor body 71 (FIG. 13) and one of the plurality of position pin holes on the inner post 12, so that the lock pin 64 of the height adjustor 70 (FIG. 13) can engage the aligned position pin holes on the overlapping portion of the outer post 11 and the inner post 12, and set the desired height of the frame structure. The outer post 11 is preferably longer than the longitudinal member 21 (FIGS. 17 and 25) of the roof truss 20 so that when in the folded position the longitudinal member 21 will not interfere with the height adjustor 70. The height adjustment mechanism enables a user to adapt to the ceiling limits in an indoor environment. The post cap bracket 13 may be affixed to the top of the outer post 11 by fasteners 14. The inner post 12 may have a foot pad to form its foundation. The foot pad may have a hole which can be, but need not be, secured to some sort of foundation, such as a ground or a wood foundation.

The preferred cross-sectional shape of the telescopic post members in the preferred embodiments is a square; however, in some embodiments tubing with various cross-sectional shapes may be used and more than two telescopic sections may be used to form the telescopic post 10. The preferred locking means for the respective position pin holes on the telescopic post 10 for height and position settings are a pin engaged by spring force, in some embodiments various locking means to engage the position pin holes can be employed, and the plurality of position pin holes on the inner post 12 may be placed on the outer post 11 instead.

FIG. 8 and FIG. 9 show the front and rear perspective views of the telescopic post 10 to illustrate the relationship of the components in the deployed position.

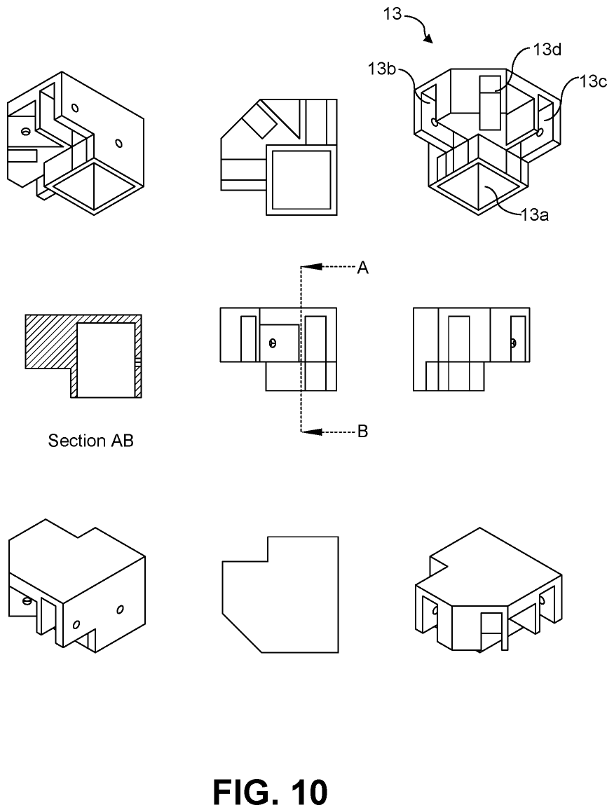

FIG. 10 shows the construction details of the post cap bracket 13 in the first preferred embodiment through a combination of orthographic, sectional and perspective views. The post cap bracket 13 may include a capped downward hollow recess 13a consisting of a plurality of sidewalls sized and shaped to receive the top end of the outer post 11, and may be affixed to the top of the outer post 11 by fasteners 14. The post cap bracket 13 may further include a plurality of downward horizontal slots radially projecting outward from the hollow recess 13a, which may include a first wall truss slot 13b, a second wall truss slot 13c and a roof truss slot 13d. The first and second wall truss slots 13b and 13c may be oriented lengthwise in accordance to the geometric footprint, and may be pivotally connected to the end portions of two adjacent longitudinal members 21 (FIG. 25) projecting upward from two respective adjacent wall trusses 20 as show on FIG. 17. The roof truss slot 13d may be oriented radially in the middle between the first and second wall truss slots (13b and 13c), and may be pivotally connected to the end portion of a first longitudinal member 31 (FIG. 28) from the roof truss 30 by fasteners as shown on FIG. 18.

FIG. 11 and FIG. 12 illustrates how the post slider bracket 60 may be constructed in the first preferred embodiment. The post slider bracket 60 may comprise a post slider boy 61, a first pin 62, a spring 63, a lock pin 64, a lever 65 and a second pin 66 (FIG. 11). The post slider body 61 may comprise a hollow tubular passage 61a (FIG. 12) having a plurality of sidewalls sized and shaped to slidably receive the outer post 11, whereby the post slider bracket 60 may slide along the outer surface(s) of the outer post 11. The post slider body 61 may further comprise a plurality of upward facing horizontal slots radially projecting outward from the hollow passage 61a on the upper post slider body 61, which may include a first wall truss slot 61b, a second wall truss slot 61c and a roof truss slot 61d oriented in similar way as the post cap bracket 13, whereby the first and second wall truss slots may be pivotally connected to the end portions of two adjacent longitudinal members 21 (FIG. 25) projecting downward from two respective adjacent wall trusses 20 as shown on FIG. 17, and the roof truss slot may be pivotally connected to the end portion of a second longitudinal member 32 (FIG. 29) from a roof truss 30 as shown on FIG. 18. The post slider body 61 may further comprise a pair of protruding hinge seats 61e (FIG. 12) on both vertical edges of a wall on the lower body, a pin hole 61f (FIG. 11) penetrating the middle of said wall above the pair of hinge seats. The horizontal slots of the post slider body 61 may be paired up with respective horizontal slots of the post cap bracket 13 on the same telescopic post 10 to be pivotally connected to respective adjacent wall trusses 20 and respective roof truss 30. The lever 65 may comprise a hollow cylinder hinge seat 65a on its upper body, a pair of protruding hinge seats 65b in the middle facing similar direction of the hollow cylinder hinge seats, a plated body bridging the hinge seat 65a and the pair of hinge seats 65b, which further extends downward to form a handle end on its lower body (FIG. 11). The lever 65 may be pivotally connected to the post slider body 61 via the hinge 66 and the spring 63, through the pair of hinge seats 65b and the pair of hinge seats 61e, forming a spring pivot. The position pin 64 sized and shaped to be received into the pin hole 61f may be pivotally connected to the hinge seat 65a via the second hinge 66, and axially aligned with the pin hole 61f. When the frame structure is in the deployed position, the pin hole 61f is further aligned with the upper position pin hole on the outer post 11 and the spring pivot enables the position pin 64 to be automatically engaged with the aligned pin holes. When the handle end of the lever 65 is pressed down, the position pin 64 is disengaged, allowing the post slider bracket 60 to slide along the outer post 11.

FIG. 13 and FIG. 14 illustrates how the height adjustor 70 may be constructed in the preferred embodiments. The height adjustor 70 may comprise a height adjustor body 71, a first pin 62, a spring 63, a position pin 64, a lever 65 and a second pin 66. The height adjustor body 71 may comprise a hollow tubular passage 71a having a plurality of sidewalls sized and shaped to receive the outer post 11, whereof the bottom end of the passage may have a narrower inward rim 71b sized and shaped to slidably receive the inner post 12, allowing the bottom of the outer post 11 to go through from the top and rest on the rim 71b at the bottom. The height adjustor body 71 may further comprise a pair of protruding hinge seats 71d on two vertical edges of a wall and a pin hole 71c sized and shaped to receive the position pin 64 penetrating the upper middle of said wall. The first pin 62, the spring 63, the position pin 64, the lever 65 and the second pin 66 may be the same as their counterparties on the post slider bracket 60. The lever 65 thereof may be pivotally connected to the height adjustor body 71, forming a spring pivot. The height adjustor assembly 70 thereof may be affixed to the bottom of the outer post 11 via fasteners or suitable bonding agents, and the pin hole 71c thereof may be axially aligned with the position pin 64 and the lower position pin hole of the outer post 11 in the fixed position. When the position pin 64 is further axially aligned with one of the plurality of position pin holes on the inner post 12 during deployment, the spring pivot enables the position pin 64 to be automatically engaged with the respective aligned pin holes. When the handle end of the lever 65 is pressed down, the position pin 64 is disengaged, allowing the outer post 11 to axially slide along the inner post 12. Therefore, the height of frame structure can be adjusted to adapt to the ceiling constrains of an indoor environment.

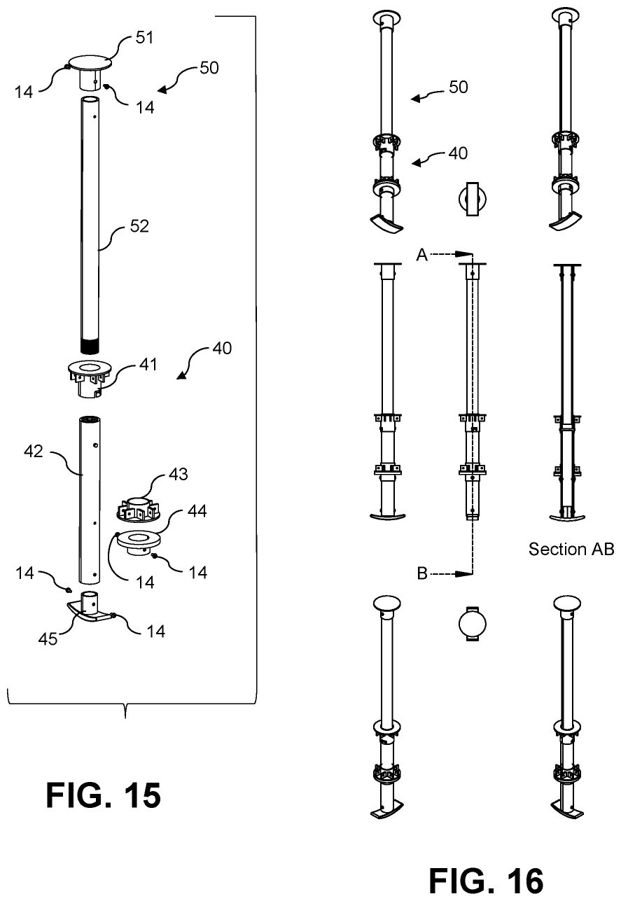

FIGS. 15-16 and FIG. 19-24 illustrates how the roof connector assembly 40 and the roof peak assembly 50 may be put together and the construction details in the preferred embodiments. The roof connector assembly 40 may comprise a roof connector 41 (FIG. 20), a roof pole 42 having a twin-tip pin 42a and an inner-threaded end 42b on the top portion (FIG. 24), a slidable connector 43 (FIG. 21), a position limit flange 44 (FIG. 22) having a flat ring plate encompassing a hollow tubular passage sized and shaped to receive the roof pole 42, and a handle 45. The roof pole 42 may be affixed to the position limit flange 44 in the middle via fasteners 14, and the handle 45 on the bottom via fasteners 14 (FIG. 15).

The roof connector 41 (FIG. 20) may comprise a hollow cylinder passage 41a sized and shaped to receive the roof pole 41 from below, and a plurality of horizontal slots 41b radially oriented, encompassing the upper portion of the hollow passage 41a and capped by a ring plate 41d. Each of the plurality of horizontal slots may be pivotally connected to the end portion of respective first longitudinal member 31 from respective roof truss 30 (FIG. 18). The roof connector 41 may further comprise a pair of locking slots 41c penetrating both of the opposite side of the lower cylinder wall, whereof each of the pair of locking slots may contain a horizontal path connected by a long vertical path having an opening to the rim of the bottom edge of lower cylinder wall on one end and a short vertical path on the other end.

The slidable connector 43 (FIG. 21) may comprise a hollow tubular passage 43a sized and shaped to slidably receive the roof pole 42, and a plurality of horizontal slots 43b radially oriented, encompassing the hollow tubular passage 43a and a ring plate 43c on the bottom end. The slidable connector 43 may be installed coaxially onto the roof pole 42 and slidable between the twin-tip pin 42a and the position limit flange 44 (FIG. 15). Each of the plurality of horizontal slots may be pivotally connected to the end portion of respective second longitudinal member 32 from respective roof truss 30 (FIG. 18). The plurality of slots on the roof connector 41 are matched and paired up with the plurality of slots on the slidable connector 43 to be pivotally connected to the roof trusses 30.

In the worksite configuration, only the roof connector assembly 40 is needed for the frame structure to form a generally flat roof frame structure in the preferred embodiments.

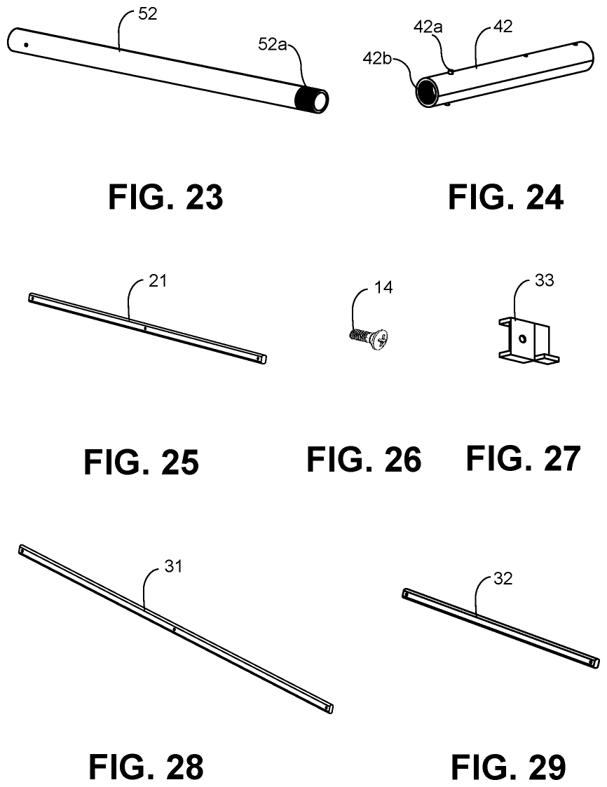

In the recreational configuration, the roof peak assembly 50 may be installed on the top of the roof connector assembly 40 to form a peaked roof in the preferred embodiments. The roof peak assembly 50 may comprise a roof peak cap 51 (FIG. 19) and a roof peak pole 52 (FIG. 23). The roof peak cap 51 may comprise a capped downward cylindrical recess sized and shaped to receive the roof peak pole 52 from below, and may be affixed to the roof peak pole 52 via fasteners 14, forming the roof peak assembly 50 (FIG. 15). The roof peak pole 52 may comprise a cylindrical tubular body having a lower threaded end 52a to be rotatably received into the inner-threaded end 42b of the roof pole 42, so as to form a roof peak.

To pop up the roof, a user may push up the handle to lock the roof pole 42 in the roof connector 41 by guiding the twin-tip pin 42a through the pair of locking slots 41c from the openings of the long vertical paths and the horizontal paths to the short vertical paths.

The tubular shape of the roof pole 42 and roof peak pole 52 in the preferred embodiments is a cylinder, however in some embodiments materials with various tubular shapes may be used. The connection between the roof pole 42 and roof peak pole 52 in the preferred embodiments is a threaded connection, however in some embodiments various means can be utilized, such as a telescopic structure.

FIG. 17 shows a perspective view of how the wall truss 20 is assembled, and connected to the post cap brackets 13 and post slider brackets 60 on both ends in the first preferred embodiment.

The wall truss 20 may comprise a plurality of X-shape arms, whereof each of the plurality of arms may consist of a pair of longitudinal members 21 (FIG. 23) preferably equal length. The pair of longitudinal members 21 may be pivotally interconnected in the middle to form a scissor linkage. The plurality of arms may be further pivotally connected to each other end-to-end in tandem, forming crisscross connections and leaving the wall truss 20 with two open ends. On each open end of the wall truss 20 the end portion of the longitudinal member 21 projecting upward may be pivotally connected to the respective first or second wall truss slot (13b or 13c) on the respective post cap bracket 13, and the end portion of the longitudinal member 21 projecting downward may be pivotally connected to the respective first or second wall truss slot (61b or 61c) on the respective post slider bracket 60.

When the post slider bracket 60 moves up closer to or moves down away from the post cap bracket 13, the crisscross connections in conjunction with the scissor linkages allow the paired-up longitudinal members 21 to extend or contract in synchronization.

FIG. 18 shows a perspective view of how the roof truss 30 is assembled, and connected to the roof connector assembly 40 on one end, a post cap bracket 13 and a post slider bracket 60 on the other end in the first preferred embodiment.

The roof truss 30 may comprise a pair of arms. Each of the pair of arms may further comprise a first longitudinal member 31 (FIG. 28) and a second longitudinal member 32 (FIG. 29), whereof the first longitudinal member 31 may be preferably longer than the second longitudinal member 32. The second longitudinal member 32 may be pivotally connected to the middle of the first longitudinal member 31 on one end, forming a brace linkage. Each first longitudinal member 31 from the pair of arms may be pivotally connected to each other end-to-end via rotation limit connector 33 (FIG. 27) and regular fastening means, leaving the roof truss 30 with two open ends. On one open end of the roof truss 30, the end portion of the first longitudinal member 31 may be pivotally connected to the respective roof truss slot 13d on the respective post cap bracket 13, and the end portion of the second longitudinal member 32 may be pivotally connected to the respective roof truss slot 61d on the respective post slider bracket 60. On the other open end of the roof truss 30, the end portion of the first longitudinal member 31 may be pivotally connected to the respective slot 41b on the roof connector 41 (FIG. 20), and the end portion of the second longitudinal member 32 may be pivotally connected to the respective slot 43b on the slidable connector 43 (FIG. 21).

The rotation limit connector 33 (FIG. 27) may comprise a similar to squared C-shape walled body on one end having a circular hole on the vertical wall of the squared C-shape body, and a L-shape walled body on the other end, whereof the L-shape body and the squared C-shape body are in tandem and back-to-back oriented. Two first longitudinal members 31 may be pivotally connected to each other end-to-end on both sides of the circular hole, and the L-shape body may limit the rotation of the respective first longitudinal member 31 sitting advantageously above the bottom wall of the L-shape body.

When the post slider bracket 60 moves up closer to or moves down away from the post cap bracket 13, the second longitudinal member 32 pushes the respective first longitudinal member 31 to extend or contract in synchronization, whereby the second longitudinal member 32 supports the overhanging roof truss 30 from the telescopic post 10.

FIG. 19-24 show the perspective views of various parts that may be used in the roof connector assembly 40 and the roof peak assembly 50.

FIG. 25 shows a perspective view of the longitudinal member 21 of the wall truss 20 having two circular holes placed on both ends and a circular hole in the middle of the body that may be used in the preferred embodiments.

FIG. 26 shows a perspective view of the fastener 14 that may be used in various assemblies in the preferred embodiments.

FIG. 27 shows a perspective view of the rotation limit connector 33 having a similar to squared C-shape body on one end, a hole on the vertical wall of the squared C-shape body, and a L-shape body on the other end that may be used in the first preferred embodiment.

FIG. 28 shows a perspective view of the first longitudinal member 31 of the roof truss 30 having two circular holes placed on both ends and a circular hole in the middle of the body that may be used in the first preferred embodiment.

FIG. 29 shows a perspective view of the second longitudinal member 32 of the roof truss 30 having two circular holes placed on both ends that may be used in the first preferred embodiment.

In the preferred embodiments, the cross-sectional shape of the wall truss and roof truss members is a stadium-shape, however, in some embodiments materials with various cross-sectional shapes may be employed.

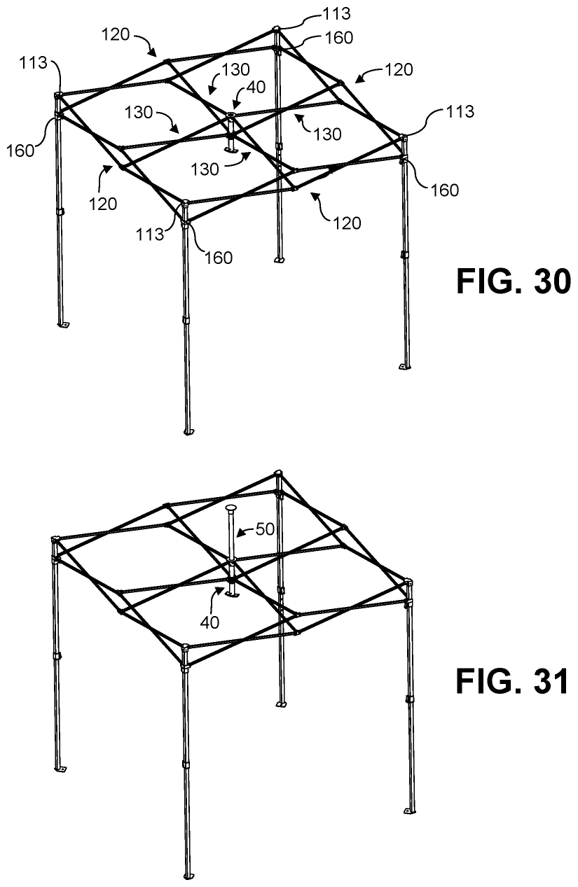

FIG. 30 shows a perspective view of a frame structure configured as a worksite in the deployed position in the second preferred embodiment. The frame structure of the second preferred embodiment may comprise mostly the same components and structure as the frame structure in the first preferred embodiment, except a second type roof truss 130 replacing the roof truss 30 may now be pivotally connected to the middle of a second type wall truss 120 replacing the roof truss 20, instead of the telescopic post 10; a second type of post cap bracket 113 (FIG. 35) may now replace the post cap bracket 13; a second type of post slider bracket 160 (FIG. 36) may now replace the post slider bracket 60; a first T connector 121 (FIG. 33) and a second T connector 122 (FIG. 34) may also be employed to complete the new connections.

FIG. 31 illustrates the frame structure configured as a recreational canopy in its deployed position in the second preferred embodiment. the roof peak assembly 50 is mounted to the top of the roof connector assembly 40 to form a peaked roof.

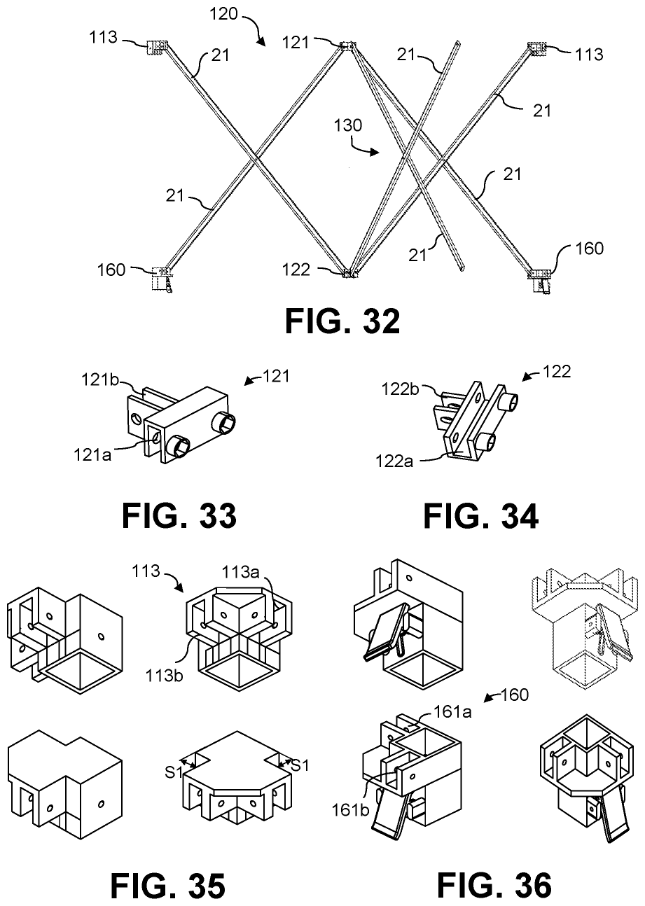

FIG. 32 illustrates how the second type wall truss 120 and the second type roof truss 130 may be put together in the second preferred embodiment. The second type wall truss 120 may comprise a first arm, a second arm with the same structure as in the first preferred embodiment, a first T connector 121 (FIG. 33) and a second T connector 122 (FIG. 34). The first T connector 121 may comprise a wall truss slot 121a forming the top of the “T” and a slightly off-center roof truss slot 121b forming the post of the “T”. The second T connector 122 may consist of a wall truss slot 122a and roof truss slot 122b the same structure as the first T connector 121, except its roof truss slot 122b may be preferably shorter than the roof truss slot 121b. Each of the first and second arms of the second type wall truss 120 may comprise a pair of longitudinal members 21 forming the same scissor linkage as in the first preferred embodiment. The first and second arms may be pivotally connected to each other end-to-end forming crisscross connection, via the wall truss slot 121a of the first T connector 121 on the top connecting two adjacent longitudinal members 21 facing outward of the geometric footprint, and the wall truss slot 122a of the second T connector 122 on the bottom connecting two adjacent longitudinal members 21 facing inward of the geometric footprint, leaving the roof truss slots 121b and 122b projecting inward of the geometric footprint and the second type wall truss 120 with two open ends. One each open end of the second type wall truss 120, the end portion of the longitudinal member 21 projecting upward may be pivotally connected to the respective wall truss slot on the respective second type post cap bracket 113 (FIG. 35), the end portion of the longitudinal member 21 projecting downward may be pivotally connected to the respective wall truss slot on the respective second type post slider bracket 160 (FIG. 36).

The second type roof truss 130 may comprise an arm preferably having the same components and structure as the first or second arm of the second type wall truss 120. On one end of the second type roof truss 130, the end portion of the longitudinal member 21 projecting upward may be pivotally connected to the roof truss slot 121b of the respective first T connector 121, and the end portion of the longitudinal member 21 projecting downward may be pivotally connected to the roof truss slot 122b of the respective second T connector 122. On the other end of the second type roof truss 130, the end portion of the longitudinal member 21 projecting upward may be pivotally connected to the respective horizontal slot 41b on the roof connector 41, and the end portion of the longitudinal member 21 projecting downward may be pivotally connected to the respective horizontal slot 43b on the slidable connector 43. The paired-up first 121 and second 122 T connectors allow the second type wall truss 120 and the second type roof truss 130 to expand and contract in synchronization.

FIG. 33 shows a perspective view of the first T connector 121 having a circular hole through the end of the roof truss slot 121b that forms the post of the “T”, and two circular holes through the wall truss slot 121a that forms the top of the “T” on both ends.

FIG. 34 shows a perspective view of the second T connector 122 having mostly the same construction as the first T connector 121, except the roof truss slot 122b is shorter.

FIG. 35 shows perspective views of the second type post cap bracket 113 from different angles in the second preferred embodiment. The second type post cap bracket 113 may have mostly the same construction as the post cap bracket 13, except on the second type post cap bracket 113 the first and second wall truss slots 113a and 113b may both be oriented with an offset S1 to its outermost surfaces that form the geometric footprint, and the roof truss slot may be eliminated.

FIG. 36 show perspective views of the second type post slider bracket 160 from different angles in the second preferred embodiment. The second type second post slider bracket 160 may have mostly the same components and construction as the post slider bracket 60, except on the second type post slider bracket 160 the first and second wall truss slots 161a and 161b may both be oriented flush with its outermost surfaces that form the geometric footprint, and the roof truss slot may be eliminated.

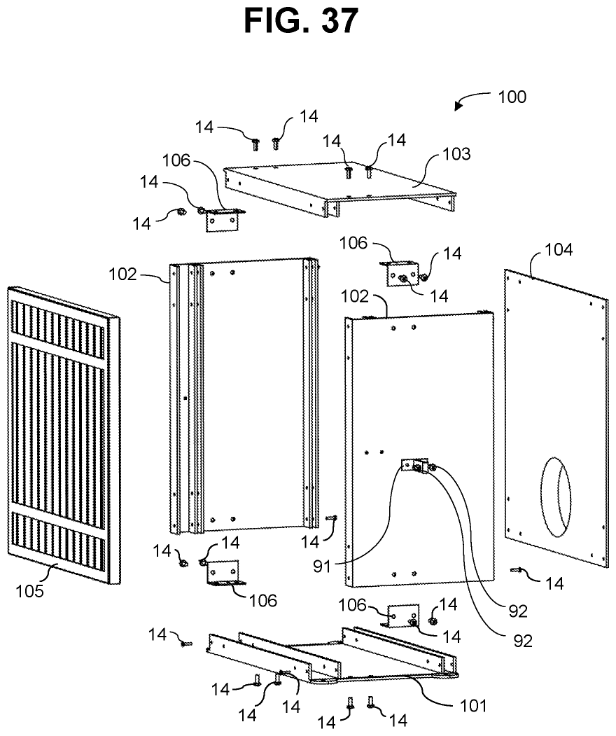

FIG. 37 illustrates how the ventilation assembly 100 may be constructed in the preferred embodiment. The ventilation assembly 100 may comprise a bottom plate 101 having a slotted surface, a pair of wall plates 102 whereof each having a slotted surface, a cap plate 103 having a slotted surface, a vent hose adapter plate 104 having a collar surrounding a penetrating hole sized and shaped to receive a standard vent hose, and an air filter 105 sourced from commercially available standard furnace air filters. The pair of wall plates 102 may be vertically jointed to the base plate 101 end-to-end on the bottom, and the cap plate 103 end-to-end on the top with all slotted surfaces facing inward, by a plurality of corner connectors 106 and a plurality of fasteners 14 to form an enclosure and an airway. The inward slotted surfaces may form a frontal slot to receive the air filter 105, a middle slot to receive the vent hose adaptor plate 104 and a rear slot to receive either a customized plate or the vent hose adaptor plate 104, so that the air way may be blocked by the air filter 105 and/or either the vent hose adaptor plate 104 or the customized plate. One of the pair of wall plates 102 may be further connected to a connector 91 (FIG. 39) from the ventilation connector assembly 90 via fasteners 92 and 84 (not shown here but shown on FIG. 39) on the exterior surface.

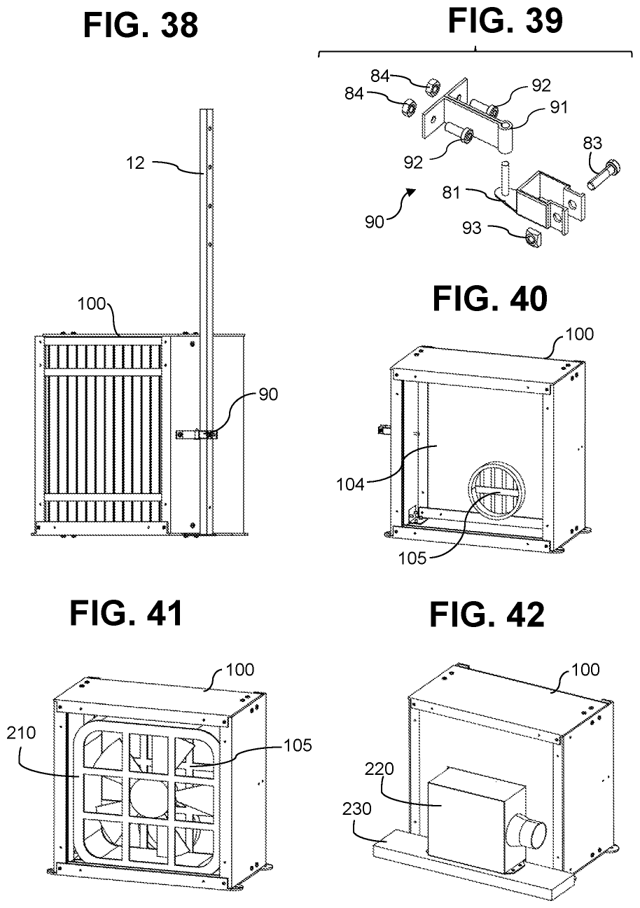

FIG. 38 shows a front perspective view of the ventilation assembly 100 attached to the inner post 12 via the ventilation connector assembly 90 in the preferred embodiment.

FIG. 39 illustrates how the ventilation connector assembly 90 may be constructed in the preferred embodiment. The ventilation connector assembly 90 may comprise a connector 91 and a connector 81. The connector 91 may contain a T-shape walled body consisting of a flat surface portion forming the top of the “T” and a protruding ridge portion having a hollow cylinder hinge seat at the end forming the post of the “T”. The flat surface portion may contain two circular holes on both sides of the ridge portion, and may be attached to a wall plate 102 via fasteners 92 and 84. The bracket end of the connector 81 may be clamped on the respective inner post 12 via fasteners 83 and 93. The ventilation assembly 100 may then be attached to the respective inner post 12 when the hinge of the connector 81 is inserted into the hollow cylinder hinge seat of the connector 91. A user may cut an opening matching the size of the air filter 105 on the wall cover and attach the opening to the ventilation assembly 100 via suitable means to expose the air filter 105. The ventilation assembly 100 may then work in conjunction with other equipment to force air in the workspace to circulate through the air filter 105, and provide ventilation to the worksite if needed. In the preferred embodiment, the ventilation assembly 100 is preferably an enclosure. However, in some embodiments the ventilation assembly may consist of a frame structure.

FIG. 40 shows a rear perspective view of the ventilation assembly 100 from the opposite direction of FIG. 38. A vent hose from a force air circulation system may be attached to the collar of the vent hose adapter plate 104.

FIG. 41 illustrates a commercially available square fan 210 may be utilized inside the ventilation assembly 100 to force air circulation.

FIG. 42 illustrates a commercially available bathroom exhaust fan 220 may be utilized alongside with the ventilation assembly 100 to force air circulation. A flat plate that has commensurate dimensions of the vent hose adapter plate 104 may be made to have a cut-out to the size of the bathroom exhaust fan 220 inlet, and seal the inlet into the ventilation assembly 100. The bathroom exhaust fan 220 may further be secured to a piece of lumber 230.

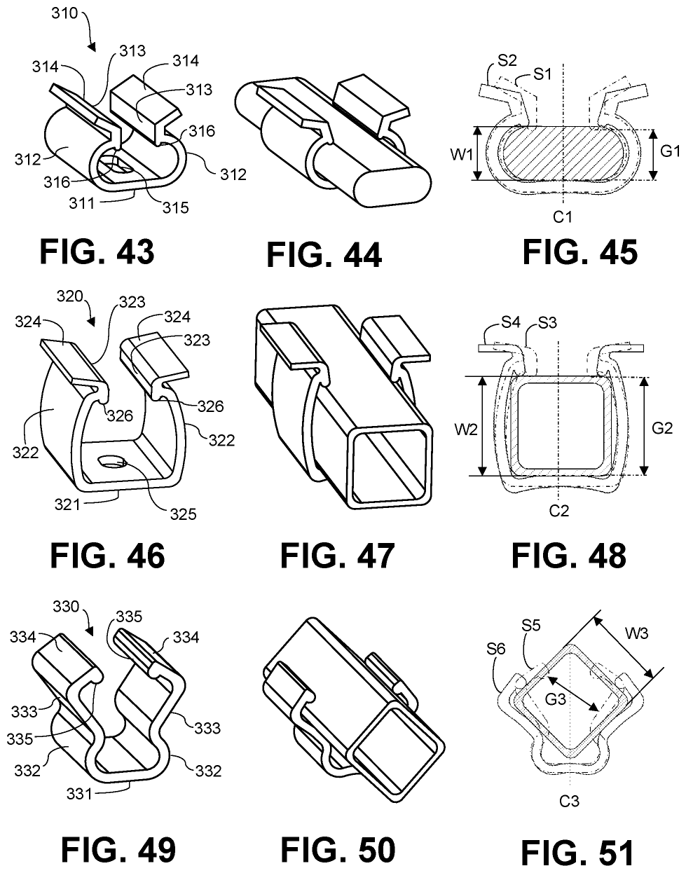

FIG. 43 shows a perspective view of a spring clip 310, which comprises a body having an enclosing longitudinal sidewall with a generally symmetric and similar to C-shape cross-section. The sidewall may consist of a generally flat base section 311 having a cut-out 315 in the center, connected on both ends by two opposing lateral sections 312 curved inwards to the symmetric center line of the cross-section C1 (FIG. 45), and disposed generally upright to the base portion 311, forming a generally partial stadium-shape; each of the two lateral sections 312 then may be connected by a neck section 313 projecting upward away from the base section 311 and containing a protruding lip 316 projecting inward towards the base section 311, forming a longitudinal opening; each of the neck sections 313 may be further connected by an outwardly disposed tab section 314, forming a lever which may be, but need not be, constructed to aid expanding the opening.

The spring clip 310 is made of resilient and elastic material, and may be used to be clamped on known-size frame members with an elongated cross-section, such as the wall truss longitudinal member 21. The size and shape are designed to closely match the frame member it's clamped on to create a generally tight fit, with the gap G1 (FIG. 45) between the tip of the protruding lip 316 and the inner surface of the base section 311 slightly shorter than the frame member's outer cross-section width W1 (FIG. 45).

FIG. 44 illustrates a spring clip 310 is clamp on a short section of an elongated frame member, such as the wall truss longitudinal member 21.

FIG. 45 shows how the cross-sectional shape of the spring clip 310 changes from its free form shape S1 to the clamped-on shape S2. The hatched area represents the cross-section of the frame member. To clamp the spring clip 310 on the targeted frame member, a user may expand the opening by bending both of the tab sections 314 outward, and push the spring clip 310 over the frame member. Since the gap G1 is shorter than the frame member's outer cross-section width W1, to conform to the contour of the circumscribed frame member, the elastic material is deformed, the lateral sections 312 are stretched and the base section 311 is inwardly bent. This increases contact areas between the base section 311 and the frame member, which leads to increased friction between the contact surfaces. The elastic force from the deformation provides the compressing force so that the spring clip 310 has a strong and firm grip on the circumscribed frame member. Therefore, when a sheeting is sandwiched between the frame member and the spring clip 310, the sheeting can be firmly secured to the frame structure. The cut-out 315 may be, but need not be, created to adjust the elastic force of the spring clip 310 when deformed.

FIG. 46 shows a perspective view of a spring clip 320, which comprises a body having an enclosing longitudinal sidewall with a generally symmetric bottle-shape cross-section. The sidewall may consist of a generally flat base section 321 having a cut-out 325 in the center, connected on both ends by two opposing lateral sections 322 curved and tilted inwards to the symmetric center line C2 of the cross-section (FIG. 48), forming a bottle body shape whereof the lateral gap is generally wider at the bottom than at the top; each of the two lateral sections 322 may be connected by a neck section 323 projecting upward away from the base section 321 and containing a protruding lip 326 projecting inward towards the base section 321, forming a longitudinal opening; each of the neck sections 323 may be further connected by an outwardly disposed tab section 324, forming a lever which may be, but need not be, constructed to aid expanding the opening.

The spring clip 320 is made of resilient and elastic material, and may be used to be clamped on known-size frame members with a square or rectangular cross-section, such as the outer post 11 and inner post 12. The size and shape are designed to closely match the frame member it's clamped on to create a generally tight fit, with the gap G2 (FIG. 48) between the tip of the protruding lip 326 and the inner surface of the base section 321 slightly shorter than the frame member's outer cross-section width W2.

FIG. 47 illustrates a spring clip 320 is clamped on a short section of a square frame member, such as the outer leg 12.

FIG. 48 shows how the cross-sectional shape of the spring clip 320 changes from its free form shape S3 to the clamped-on shape S4. The hatched area represents the cross-section of the frame member. To clamp the spring clip 320 on the targeted frame member, a user may expand the opening by bending the tab sections 324 outward, and push the spring clip 320 over the frame member. Since the gap G2 is shorter than the frame member's outer cross-section width W2, to conform to the contour of the circumscribed frame member, the elastic material is deformed, the lateral sections 322 are stretched and the base section 321 is inwardly bent. This increases contact areas between the base section 321 and the frame member, which leads to increased friction between the contact surfaces. The elastic force from the deformation provides the compressing force so that the spring clip 320 has a strong and firm grip on the circumscribed frame member. Therefore, when a sheeting is sandwiched between the frame member and the spring clip 320, the sheeting can be firmly attached to the frame structure. The cut-out 325 may be, but need not be, created to adjust the elastic force of the spring clip 320 when deformed.

FIG. 49 shows a perspective view of a spring clip 330, which comprises a body having an enclosing longitudinal sidewall with a generally symmetric and similar to V-shape cross-section. The sidewall may consist of a generally flat base section 331, connected on both ends by two opposing lateral sections 332 curved inwards to the symmetric center line C3 of the cross-section (FIG. 48), forming a base with a generally partial stadium-shape; each of the two lateral sections 332 may be connected by a V-wall section 333 projecting upward away from the base section 331 and outward from the symmetric center line C3, forming one side of the V-shape; each V-wall section 333 may be further connected by an enclosing section 334 erecting inwards to the symmetric center line C3 from the V-wall section 333 and containing a protruding lip 335 at the end projecting towards the opposing V-wall section 333, forming a longitudinal opening.

The spring clip 330 is made of resilient and elastic material, and may be used to be clamped on known-size frame members with a square or rectangular cross-section, such as the outer post 11 and inner post 12. The size and shape are designed to closely match the frame member it's clamped on to create a generally tight fit, with the gap G3 (FIG. 51) between the tip of the protruding lip 335 and the inner surface of the opposing V-wall section 332 slightly shorter than the frame member's outer cross-section width W3.

FIG. 50 illustrates a spring clip 330 is clamped on a short section of a square frame member, such as the outer leg 12.

FIG. 51 shows how the cross-sectional shape of the spring clip 330 changes from its free form shape S5 to the clamped-on shape S6. The hatched area represents the cross-section of the frame member. To clamp the spring clip 330 on the targeted frame member, a user may push the spring clip 330 over the frame member. Since the gap G3 is shorter than the frame member outer cross-section width W3, to conform to the contour of the circumscribed frame member, the elastic material is deformed, the V-wall sections 333 are inwardly bent, the lateral sections 332 are stretched and the base section 331 is inwardly bent. This increases contact areas between the V-wall sections 333 and the frame member, which leads to increased friction between the contact surfaces. The elastic force from the deformation provides the compressing force so that the spring clip 330 has a strong and firm grip on the circumscribed frame member. Therefore, when a sheeting is sandwiched between the frame member and the spring clip 330, the sheeting can be firmly attached to the frame structure.

In the preferred embodiment, the shape of the base of the spring clip 330 is a partial stadium-shape; however, in some embodiments the shape of the base can be various enclosing shapes such as a partial circular shape or oval shape.

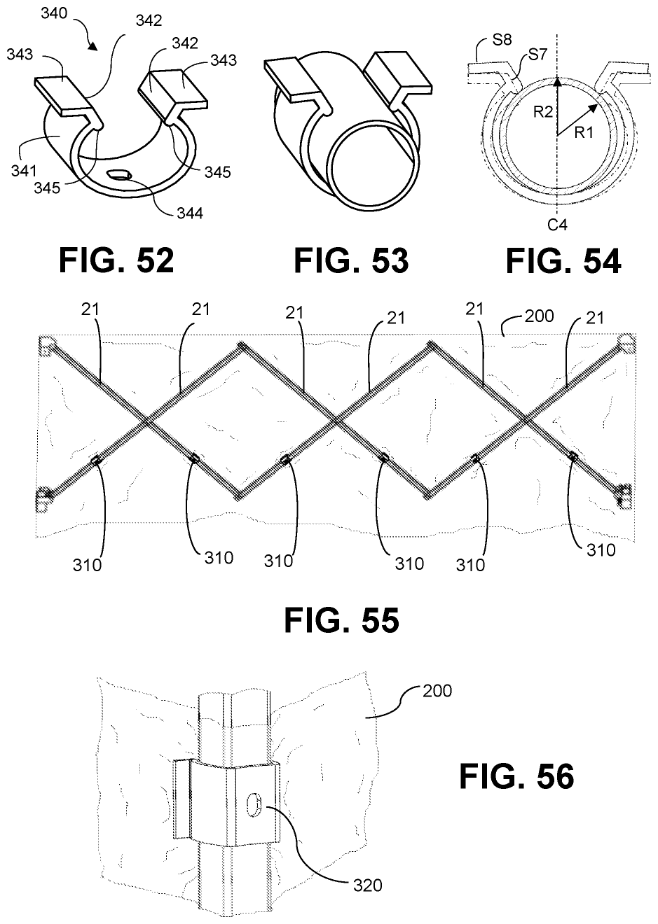

FIG. 52 shows a perspective view of a spring clip 340 that may be used when cylindrical frame members are desired, which comprises a body having an enclosing longitudinal sidewall with a generally symmetric and similar to C-shape cross-section. The sidewall may consist of a main body section 341 having a generally partial oval shape and a cut-out 344 in the center, connected on both ends by two neck sections 342 projecting outward away from the center of the oval shape and containing a protruding lip 345 projecting inwards to the center of the oval shape, forming a longitudinal opening. Each of the neck sections 342 may be further connected by an outwardly disposed tab section 343, forming a lever which may be, but need not be, constructed to aid expanding the opening.

The spring clip 340 is made of resilient and elastic material, and may be used to be clamped on known-size frame members with a cylindrical cross-section, such as a round frame member. The size and shape are designed to closely match the frame member it's clamped on to create a generally tight fit, with the radius R1 (FIG. 54) between the tip of the protruding lip 345 and the center of the oval cross-section slightly shorter than the frame member's outer cross-section radius R2.

FIG. 53 illustrates a spring clip 340 is clamp on a short section of a round frame member.

FIG. 54 shows how the cross-sectional shape of the spring clip 340 changes from its free form shape S7 to the clamped-on shape S8. The hatched area represents the cross-section of the frame member. To clamp the spring clip 340 on the targeted frame member, a user may expand the opening by bending the tab sections 343 outward, and push the spring clip 340 over the frame member. Since the radius R1 is shorter than the frame member's outer cross-section radius R2, to conform to the contour of the circumscribed frame member, the elastic material is deformed, the main body section 341 is stretched on both ends along the direction to the tips of the protruding lips 345. This increases contact areas between the contact surfaces of the main body section 341 and the circumscribed frame member, which leads to increased friction between the contact surfaces. The elastic force from the deformation provides the compressing force so that the spring clip 340 has a strong and firm grip on the circumscribed frame member. Therefore, when a sheeting is sandwiched between the frame member and the spring clip 340, the sheeting can be firmly secured to the frame structure. The cut-out 344 may be, but need to be, created to adjust the elastic force of the spring clip 340 when deformed.

FIG. 55 further illustrates how a clear sheeting 200 may be sandwiched between the longitudinal members 21 and the spring clips 310, whereby secured to the frame structure in the preferred embodiments.

FIG. 56 further illustrates how a clear sheeting 200 may be sandwiched between a telescopic post member, such as the outer post 11 or the inner post 12, and the spring clips 320, whereby secured to the frame structure in the preferred embodiments.

Working examples have proven the above-mentioned spring clips can provide strong and firm grip to secure the sheeting to the frame members, and withstand significant dragging forces on the sheeting cover.

To further accommodate existing frame structures consisting of frame members with various sizes and cross-sectional shapes, which a user may have already possessed, a second universal clamping system is also disclosed, whereby a user may covert an existing recreational frame structure, such as a canopy, into a temporary worksite, by utilizing the second universal clamping system to attach commercially available sheeting as disposable cover to the existing frame structures.

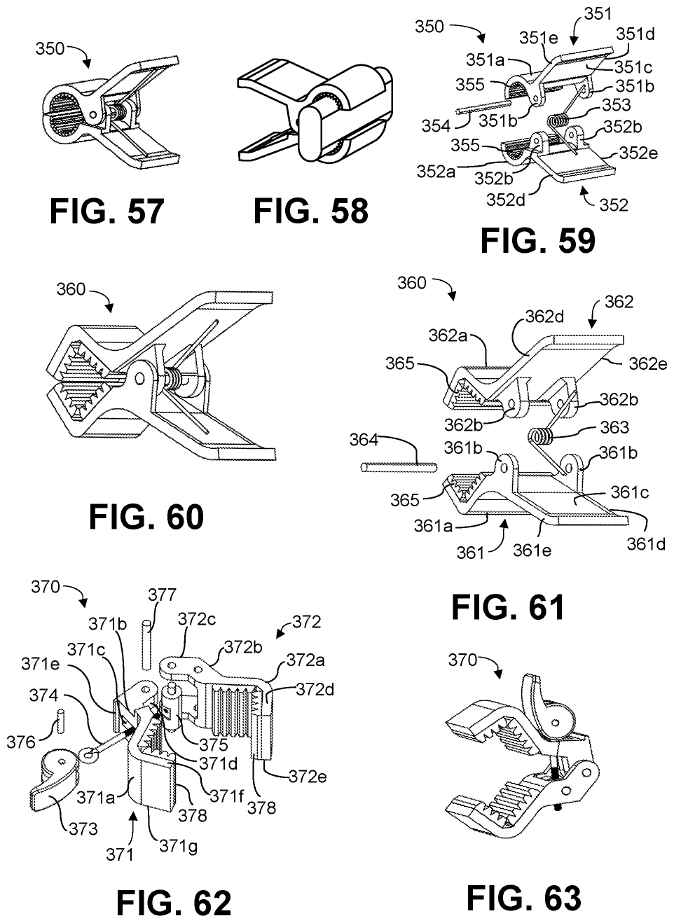

FIG. 57-58 show the perspective views of a spring clamp 350 which may be used to clamp sheeting onto a frame member with elongated cross-section in the preferred embodiment.

FIG. 59 illustrates how the spring clamp 350 may be constructed. The spring clamp 350 may comprise a first arm 351, a second arm 352, a spring 353, a hinge 354 and a pair of teethed pads 355. The first arm 351 may consist of a jaw end 351a having a curved longitudinal sidewall with a depressed side and a vaulted side, connected by a pair of protruding hinge seats 351b in the middle spaced apart along two longitudinal edges 351d and 351e and facing similar direction as the depressed side of the jaw end, whereof further connected by a plated lever end 351c disposed with an obtuse angle relative to the tangent of the portion of sidewall of the jaw end adjacent to the pair of hinge seats. The two longitudinal edges 351d and 351e define the length of the first arm. The second arm 352 may have mostly the same construction as the first arm 351, except the pair of hinge seats 352b are spaced apart with inward offset from two longitudinal edges 352d and 352e, to couple with the pair of hinge seats 351b. The first arm 351 and the second arm 352 are pivotally interconnected via the spring 353 and the hinge 354, having the depressed sides of the jaw ends 351a and 352a facing each other, and forming a spring clamp with a pair of jaws, a spring pivot and a pair of levers. The pair of teethed pads 355 may comprise longitudinally vaulted teeth having a generally triangular cross-sectional shape and are sized and shaped to be bonded to the inner surfaces on the depressed sides of the jaw ends 351a and 352a by suitable means. The pair of teethed pads 355 are made of resilient and elastic material and the triangular cross-sectional tooth shape is created to better conform to the contours of frame members with smaller cross-sectional dimensions, such as the wall truss longitudinal member 21. In some embodiments when the elastic material is pliable enough the pair of pads may have no teeth.

A user may use the spring clamp 350 to attach a sheeting to a slender frame member such as the wall truss longitudinal member 21, by sandwiching the sheeting between the frame member and the pair of teethed pads 355. The spring force provides the compressing force from the pair of levers for the deformation of the elastic teeth pads 355, creating multiple contact areas between the teeth and the circumscribed frame member, which leads to increased friction. The jaw ends of the first arm 351 and second arm 352 form a variable gapped opening, which accommodates frame members with various sizes.

FIG. 60 shows a perspective view of a spring clamp 360 in another embodiment, which may be used to quickly secure a sheeting to frame members with various non-elongated cross-section, such as securing the entrance cover to a telescopic post 10 to close the workspace and taken off when exiting the workspace.

FIG. 61 illustrates how the spring clamp 360 may be constructed. The spring clamp 360 may comprise a first arm 361, a second arm 362, a spring 363, a hinge 364 and a pair of teethed pads 365. The first arm 361 may consist of a jaw end 361a having a generally V-shape longitudinal sidewall with a depressed side and a vaulted side, whereof connected by a pair of protruding hinge seats 361b in the middle spaced apart along two longitudinal edges 361d and 361e, and facing similar direction as the depressed side of the jaw end 361a, whereof further connected by a plated lever end 361c disposed with an obtuse angle relative to the portion of sidewall of the jaw end 361a adjacent to the pair of hinge seats 361b. The two longitudinal edges 361d and 361e define the length of said first arm. The second arm 362 may have mostly the same construction as the first arm 361, except the pair of hinge seats 362b are spaced apart with inward offset from two longitudinal edges 362d and 362e to couple with the pair of hinge seats on the first arm 361. The first arm 361 and the second arm 362 may be pivotally interconnected on corresponding pairs of hinge seats 361b and 362b via the spring 363 and the hinge 364, having the depressed sides of the jaw ends 361a and 362a facing each other, and forming a spring clamp with a pair of jaws, a spring pivot and a pair of levers. The pair of teethed pads 365 may comprise longitudinally vaulted teeth having a generally trapezoidal cross-sectional shape and are sized and shaped to be bonded to the inner surfaces on the depressed sides of the jaw ends 361a and 362a by suitable means. The pair of teethed pads 365 are made of resilient and elastic material and the flat-top teeth are created to better conform to the contour of frame members with a larger cross-sectional dimensions and flatter outer surfaces, such as the outer leg 11, so as to increase contact areas. In some embodiments when the elastic material is pliable enough the pair of pads may have no teeth.

A user may use the spring clamp 360 to attach a sheeting to a frame member with non-elongated cross-section, by sandwiching the sheeting between the frame member and the pair of teethed pads 365. The spring force provides the compressing force from the pair of levers for the deformation of the elastic teeth pads 365, creating multiple contact areas between the teeth and the circumscribed frame member, which leads to increased friction. The jaw ends of the first arm 361 and second arm 362 form a variable gapped opening, which accommodates frame members with various sizes.

FIG. 62-63 illustrate how a locking clamp 370, which may be used to clamp a sheeting onto a frame member with various non-elongated cross-sections for relatively longer term and/or for stronger grip than the spring clamp 360, may be constructed in the preferred embodiment.

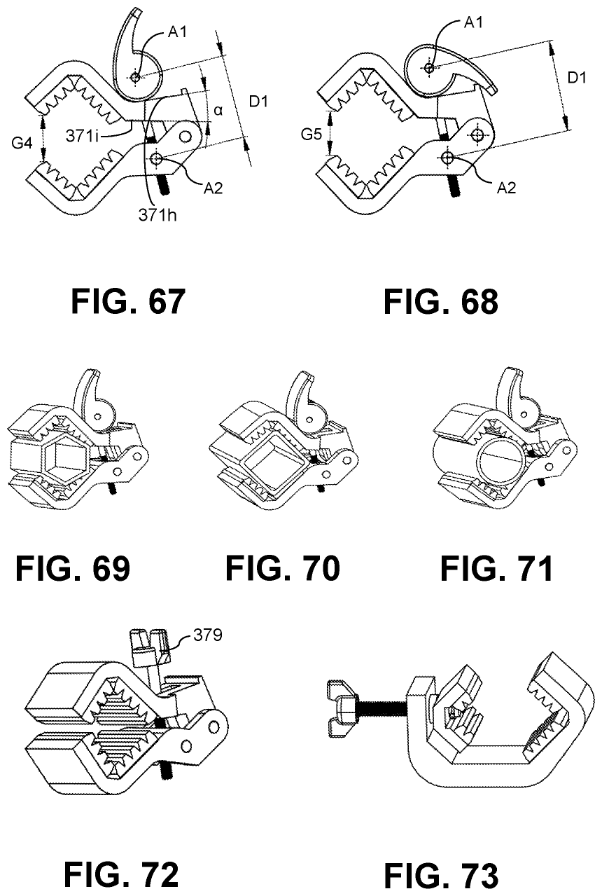

The locking clamp 370 (FIG. 62) may comprise a first arm 371, a second arm 372, an actuator 373, a ring bolt 374, a swivel nut 375, a first hinge 376, a second hinge 377 and a pair of teethed pads 378. The first arm 371 may consist of a jaw end 371a having a generally V-shape longitudinal sidewall with a depressed side and a vaulted side, connected by a lever section 371b consisting of a longitudinal sidewall having two longitudinal edges offset inwardly from two longitudinal edges 371f and 371g, which is disposed with an obtuse angle relative to the adjacent portion of sidewall of the jaw end 371a, and has a notched cut-out 371c in the middle and a protruding lip 371e at the end; thereof the lever section 371b may be further connected by a forked hinge end having a pair of protruding hinge seats spaced apart along the two longitudinal edges of the lever portion 371b and facing similar direction as the depressed side of the jaw end 371a. The two longitudinal edges 371f and 371g define the length of the first arm 371. The outer surface of the lever section 371b forms a camming surface 371h (FIG. 67) to seat the actuator 373.

The second arm 372 may consist of a jaw end 372a having a generally V-shape longitudinal sidewall, connected by a lever section 372b consisting of a section of longitudinal sidewall with an obtuse angle relative to the adjacent portion of sidewall of the jaw end 372b, followed by two forked transverse sidewalls along two longitudinal edges 372d and 372e, whereof each of the two transverse sidewalls contains a bore coaxial to each other forming a first pair of hinge seats; thereof the two transverse sidewalls further extend towards similar direction as the depressed side of the jaw end 372a, forming a protruding hinge end consisting of a second pair of hinge seats; whereby the first arm 371 and the second arm 372 are pivotally interconnected on their hinge ends 371d and 372c via the second hinge 377.

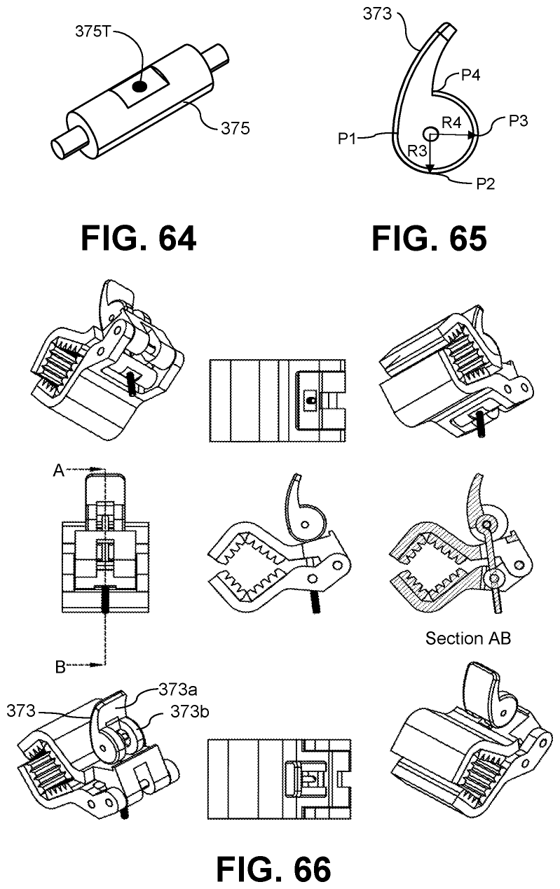

The ring bolt 374 (FIG. 62) may comprise a ring end and a bolt end, whereof the ring end is pivotally connected to the actuator 373 via the first hinge 376 and the bolt end is disposed through the notched cut-out 371c and rotatably received into the swivel nut 375. The swivel nut 375 (FIG. 64) may comprise a first hinge end connected by a larger diameter cylindrical nut section having a centrally disposed inner-threaded hole 375T sized to rotatably receive the bolt end of the ring bolt 374, which is further connected by a second hinge end coaxial to and same size as the first hinge end, thereof the swivel nut is pivotally connected to the first pair of hinge seats on the lever section 372b. The pair of teethed pads 378 may comprise longitudinally vaulted teeth having a generally trapezoidal cross-sectional shape and are sized and shaped to be bonded to the inner surfaces on the depressed sides of the jaw ends 371a and 372a by suitable means. The pair of teethed pads 372 are made of resilient and elastic material and the flat-top teeth are created to better conform to the contours of frame members with larger dimensions and flatter outer surfaces, such as the outer leg 11, so as to increase contact areas. In some embodiments when the elastic material is pliable enough the pair of pads may have no teeth.

The actuator 373 may comprise a longitudinal body having a lever end 373a, and a cam end 373b (FIG. 66), thereof the cam end 373b may comprise a pair cam discs spaced apart along two longitudinal edges, forming a pair of hinge seats; thereof the lever end 373a may bridge the pair of cam discs and further project away from the cam end 373b transversely; thereof each of the pair of cam discs may contain a curved longitudinal camming surface and a bore disposed off-center sized to pivotally receive the first hinge 376 and coaxial to each other; whereof the camming surface may consist of a first surface with a smaller constant radius curvature extending from the lever end 373a, followed by a second surface having a variable radius curvature with gradually increasing radius, followed by a third surface with a larger constant radius curvature meeting the lever end 373a, whereof the radius is measured transversely from the axis of the bore to the camming surface. Referring to the cross-sectional shape of the actuator 372 as shown on FIG. 65, the curvature from point P1 to point P2 may have a smaller constant radius R3, the curvature from point P2 to point P3 may have a gradually increasing radius ranging from R3 to R4, and the curvature from point P3 to point P4 may have a constant radius R4. The cam end 371b may be pivotally connected to the ring bolt 374 on the ring end via first hinge 376, and may rotate around the longitudinal axis of the ring bolt 374 and the axis of the first hinge 376, with the camming surface of the cam end 373b interacting with camping surface 371h (FIG. 67). In some embodiments, the actuator may have a ball-shape and the camming surface of the first arm may be a concave surface to interact with the ball-shape actuator.

FIG. 67-68 illustrate how the actuator 371 locks the locking clamp 370 in place. A user may use the locking clamp 370 to attach a sheeting to a frame member by sandwiching the sheeting between the frame member and the pair of teethed pads 378; the user may rotate the actuator 373 around the longitudinal axis of the ring bolt 374 to drive the ring bolt 374 further into the swivel nut 375. When the ring bolt 374 is fully tightened, the pair of teethed pads 378 are deformed to conform to contour of the contact surfaces on the circumscribed frame member, forming multiple contact areas, whereby creating an initial gap G4 between the outmost edges of the pair of teethed pads 378, and a distance D1 between axis A1 and axis A2. The user may then rotate the actuator 373 clock-wise around the axis A1 on the camming surface of the cam end 373b, which is in contact with the camming surface 371h (FIG. 67), until stopped by the protruding lip 371e, thereof creating a locked position for the locking clamp 370. Since the distance D1 is constant and the radius measured from axis A1 to the contact point of the camming surface increases when the actuator 373 turns clock-wise around axis A1, the initial gap G4 is reduced to G5 presuming the circumscribed frame member is not in the way. When the circumscribed frame member is accounted for this translates into more compressing force and more deformation of the pair of teethed pads 378, which further increases the friction between the sandwiched sheeting and the circumscribed frame member. The sloped angle α between the camming surface 371h and the bottom surface 371i of the lever section 371b is designed to urge the actuator to stay at the bottom of the slope and maximize mechanical advantage.

FIGS. 69-68 illustrate how the locking clamp 370 can accommodate frame members with diverse cross-sectional shapes and serve as a universal clamp.

FIG. 72 shows another embodiment of the locking clamp, whereof the actuator 373 and the ring bolt are replaced by a wing bolt 379, to further demonstrate how the principles can be applied to different embodiments.

FIG. 73 shows yet another embodiment of the locking clamp, whereof the locking clamp may have a vise structure with a fixed vise and a movable vise rotatably connected to a wing bolt, thereof the compressing force is provided by rotating the wing bolt further into the inner-threaded end of the fixed vise, to further demonstrate how the principles can be applied to different embodiments.

Working examples have proven the above-mentioned clamp embodiments can provide strong grip to firmly secure the sheeting to the frame members, and withstand significant dragging forces on the sheeting cover.

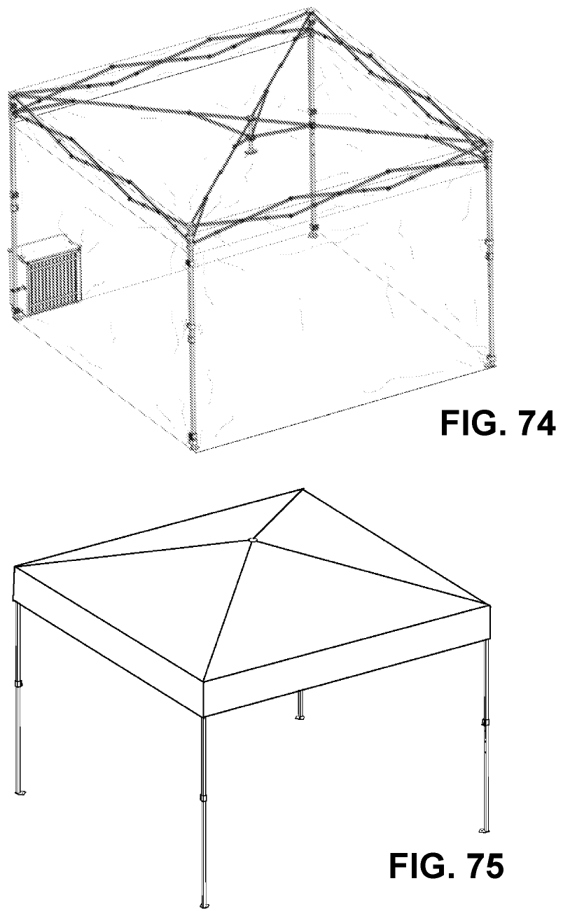

FIG. 74 illustrates a single unit of the frame structure in full worksite configuration and deployed state in the first preferred embodiment. The frame structure may be popped up without tools. A desired roof height may be set. A user may first cover the flat roof with clear sheeting, then wraps another clear sheeting along the telescopic posts 10 to form the walls and secured by a plurality of spring clips 320 as shown on FIG. 56, starting from the front left telescopic post as the first telescopic post, to the left one in the rear as the second telescopic post, to the right one in the rear as the third telescopic post, and the front right one as the fourth telescopic post. The overlapping portion of the roof cover and wall cover may be secured to the longitudinal members 21 via a plurality of spring clips 310 as shown on FIG. 55. The clear sheeting may then form an entry cover between the first post and the fourth post. The top of the entry cover may be secured to the longitudinal members 21 on the top of the entry via a plurality of spring clips 310. A user may enter the workspace through the entry, then seal off the workspace by using a plurality of spring clamp 360 to attach the free side of the entry cover to the first telescopic post 10 from inside. The ventilation assembly 100 may be attached to the second telescopic post along the geometric footprint if needed. A ground cover may also be used to cover the ground of the worksite if needed.

For an existing frame structure made of commonly used materials, such as tubular materials with various cross-section shapes, which a user may have already owned, a combination of universal spring clamp 350, spring clamp 360 and locking clamp 370 may be used to convert an existing asset into a temporary worksite.

FIG. 75 shows a single unit of frame structure in the preferred embodiments, is converted from a temporary worksite as shown on FIG. 74 to a recreational canopy, by installing the roof peak assembly 50 and put on a tailored roof cover to form a peaked roof canopy.

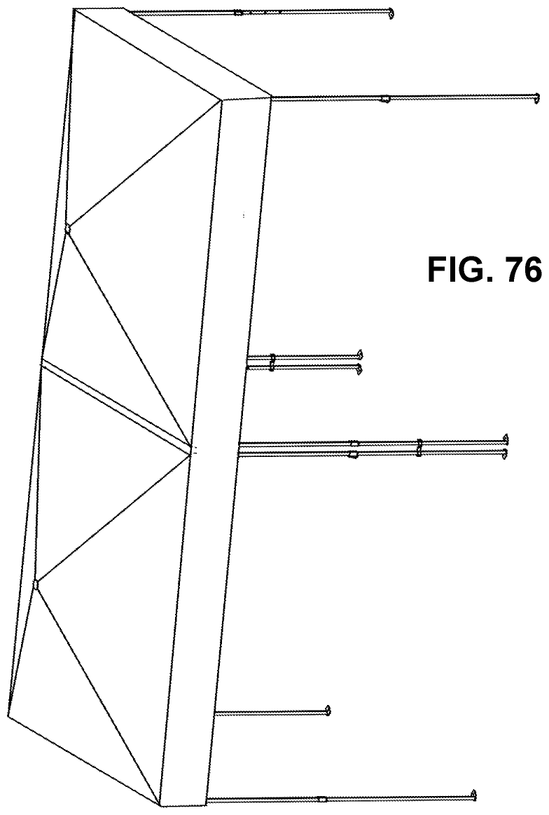

FIG. 76 further shows two identical units of frame structure in recreational configuration in the preferred embodiments, can be scaled up by linking two frame structure with frame linkage assemblies 80 as shown on FIG. 4, and covered by a tailored roof cover to form a twin-peak recreational canopy.

1. A scalable and portable multipurpose worksite frame structure comprising:
first, second, third and fourth telescopic posts standing vertically on the ground, wherein the outermost surfaces of said first, second, third and fourth telescopic posts form a closed loop geometric footprint, wherein said telescopic posts define the vertices of said geometric footprint and are extendable and retractable;
at least one wall truss having a plurality of longitudinal members operably and transversely attached to and between adjacent said first, second, third and fourth telescopic posts forming a closed loop wall frame structure, wherein said at least one wall truss is extendable and foldable;
a roof connector assembly disposed centrally of said geometric footprint;
a roof peak assembly disposed centrally of said geometric footprint;
at least one roof truss having a plurality of longitudinal members operably and transversely attached to and between said roof connector assembly and said wall frame structure forming a roof, wherein said at least one roof truss is extendable and foldable;
wherein said frame structure includes a deployed position whereof said telescopic posts are extended vertically, said at least one wall truss and said at least one roof truss are extended transversely;
wherein said frame structure includes a worksite configuration having no said roof peak assembly mounted and characterized with a generally flat roof;
wherein said frame structure includes a recreational configuration having said roof peak assembly mounted coaxially on top of said roof connector assembly and characterized with a peaked roof;
wherein a worksite is scaled up by linking two said frame structures in said deployed position and in said worksite configuration side by side;
wherein a recreational space is scaled up by linking two said frame structures in said deployed position and in said recreational configuration side by side; and
wherein said frame structure includes a folded position whereof said roof peak assembly is dismounted, said telescopic posts are retracted, said at least one wall truss and said at least one roof truss are folded and bunched together in compact storage form.

2. The frame structure as in claim 1, wherein said roof connector assembly further comprises:
a roof pole;
a first roof connector having a tubular side-walled body sized and shaped to receive the top portion of said roof pole, and a plurality of slots radially oriented encompassing said tubular side-walled body;
a second roof connector having a tubular side-walled body sized and shaped to receive the lower portion of said roof pole, and a plurality of slots radially oriented encompassing said tubular side-walled body;
wherein said plurality of slots of said first roof connector are matched and paired up with said plurality of slots of said second roof connector to connect with respective said at least one roof truss; and
wherein said roof pole is stationarily attached to said first roof connector on the top portion, and said second roof connector on the lower portion in said deployed position in said worksite configuration.

3. The frame structure as in claim 1, wherein said roof peak assembly further comprises:
a roof peak pole sized and shaped to be attached to the top end of said roof pole;
a roof peak cap having a capped hollow recess sized and shaped to receive said roof peak pole from below;
wherein said roof peak cap is stationarily attached to the top end of said roof peak pole; and
wherein said roof peak pole is coaxially mounted on the top end of said roof connector assembly to extend the roof height and form a roof peak in said recreational configuration.

4. The frame structure as in claim 1, wherein said at least one roof truss is operably and transversely connected to and between said roof connector assembly and the top portions of said first, second, third and fourth telescopic posts.

5. The frame structure as in claim 4, wherein a telescopic post of said first, second, third and fourth telescopic posts further comprises:
an outer post having a tubular body;
an inner post sized and shaped to be slidably received into said outer post;
a post cap bracket further comprising a hollow recess sized and shaped to receive the top end of said outer post, and a plurality of slots radially projecting outward from said hollow recess including a first wall truss slot, a second wall truss slot and a roof truss slot; wherein said first and second wall truss slots are oriented lengthwise in accordance to said geometric footprint and said roof truss slot is oriented radially between said first and second wall truss slots; wherein said post cap is affixed to the top of said outer post;
a post slider bracket having a hollow tubular passage sized and shaped to slidably receive said outer post, and a plurality of slots radially projecting outward from said hollow tubular passage including a first wall truss slot, a second wall truss slot and a roof truss slot; wherein said first and second wall truss slots are oriented lengthwise in accordance to said geometric footprint and said roof truss slot is oriented radially between said first and second wall truss slots;
wherein said outer post slidably receives said inner post to form the telescopic structure;
wherein said first, second, third and fourth telescopic posts are extendable and retractable in height; and
wherein said post slider bracket is slidably attached to said outer post and slides along the outer surface(s) of said outer post when extending or folding said frame structure.

6. The frame structure as in claim 4, wherein said at least one wall truss further comprises at least one arm having a first and a second longitudinal member that are equal length, thereof said first and second longitudinal members are pivotally interconnected in the middle to form a scissor linkage; wherein said at least one arm further comprises a first arm, a second arm and a third arm, thereof said first, second and third arms are further pivotally connected end-to-end in tandem forming crisscross connections, and leaving said at least one wall truss with two open ends; wherein on each open end of said at least one wall truss a longitudinal member of said first and second longitudinal members projecting upward is pivotally connected to corresponding said first or second wall truss slot on respective said post cap bracket; and wherein on each open end of said at least one wall truss a longitudinal member of said first and second longitudinal members projecting downward is pivotally connected to corresponding said first or second wall truss slot on respective said post slider bracket.

7. The frame structure as in claim 4, wherein said at least one roof truss further comprises at least one arm having a first and a second longitudinal member, thereof said second longitudinal member is shorter than said first longitudinal member, and is pivotally connected to the middle of said first longitudinal member on one end, forming a brace linkage; wherein said at least one arm further comprises a first arm and a second arm; wherein said first longitudinal member of said first arm is pivotally connected to corresponding said roof truss slot of respective said post cap bracket on one end, and said first longitudinal member of said second arms on the other end; wherein said first longitudinal member of said second arm is pivotally connected to one of said plurality of slots on said first roof connector on the other end; wherein said second longitudinal member of said first arm is pivotally connected to corresponding said roof truss slot on respective said post slider bracket on the other end; wherein said second longitudinal member of said second arm is pivotally connected to one of said plurality of slots on said second roof connector on the other end.

8. The frame structure as in claim 1, wherein said at least one roof truss is operably and transversely connected to and between said roof connector assembly and the midpoint of said at least one wall truss.

9. The frame structure as in claim 8, wherein a telescopic post of said first, second, third and fourth telescopic posts further comprises:
an outer post having a tubular body;
an inner post sized and shaped to be slidably received into said outer post;
a post cap bracket further comprising a hollow recess sized and shaped to receive the top end of said outer post, and a plurality of slots radially projecting outward from said hollow recess including a first wall truss slot and a second wall truss slot; wherein said first and second wall truss slots are oriented lengthwise in accordance to said geometric footprint; wherein said post cap bracket is affixed to the top of said outer post;
a post slider bracket having a hollow tubular passage sized and shaped to slidably receive said outer post, and a plurality of slots radially projecting outward from said hollow tubular passage including a first wall truss slot and a second wall truss slot; wherein said first and second wall truss slots are oriented lengthwise in accordance to said geometric footprint;
wherein said outer post slidably receives said inner post to form the telescopic structure;
wherein said first, second, third and fourth telescopic posts are extendable and retractable in height; and
wherein said post slider bracket is slidably attached to said outer post and slides along the outer surface(s) of said outer post when extending or folding said frame structure.

10. The frame structure as in claim 8, wherein said at least one wall truss further comprises at least one arm having a first and a second longitudinal member that are equal length, thereof said first and second longitudinal members are pivotally interconnected in the middle to form a scissor linkage; wherein said at least one arm further comprises a first arm and a second arm, thereof said first and second arms are further pivotally connected end-to-end, forming crisscross connection between said first and second arms, an upper midpoint junction and a lower midpoint junction, and leaving said at least one wall truss with two open ends; wherein on each open end of said at least one wall truss a longitudinal member of said first and second longitudinal members projecting upward is pivotally connected to corresponding said first or second wall truss slot on respective said post cap bracket, and a longitudinal member of said first and second longitudinal members projecting downward is pivotally connected to corresponding said first or second wall truss slot on respective said post slider bracket.

11. The frame structure as in claim 8, wherein said at least one roof truss further comprises at least one arm, whereof said at least one arm further comprises an arm having a first and a second longitudinal member that are equal length, thereof said first and second longitudinal members are pivotally interconnected in the middle to form a scissor linkage, and leaving said at least one roof truss with two open ends; wherein on one open end of said at least one roof truss a longitudinal member of said first and second longitudinal members projecting upward is pivotally connected to respective said upper midpoint junction of respective said at least one wall truss, and a longitudinal member of said first and second longitudinal members projecting downward is pivotally connected to respective said lower midpoint junction of respective said at least one wall truss; wherein on another open end of said at least one roof truss a longitudinal member of said first and second longitudinal members projecting upward is pivotally connected to one of said plurality of slots on said first roof connector, and a longitudinal member of said first and second longitudinal members projecting downward is pivotally connected to one of said plurality of slots on said second roof connector.

12. A ventilation system comprising:
an air filter;
a vent hose adaptor plate having a collar surrounding a circular hole;
an enclosure further comprising a base plate, at least one wall plate and a cap plate; wherein said at least one wall plate further comprises a first wall plate and a second wall plate; wherein said first wall plate and second wall plates are vertically connected to said base plate end-to-end on the bottom and said cap plate end-to-end on the top to form said enclosure and an airway; wherein said enclosure receives said air filter and said vent hose adaptor plate to block said airway;
wherein to utilize an existing external air circulation device, said air filter and said vent hose adaptor plate are received into said enclosure, and a vent hose is used to connect said external air circulation device to the collar of said vent hose adaptor plate;
wherein to utilize an existing blower fan, said air filter is received into said enclosure and said blower fan is placed inside said enclosure; and
wherein to utilize an existing bathroom exhaust fan, said air filter is received into said enclosure, and a customized plate is made to be received into said enclosure to seal the inlet of said bathroom exhaust fan into said enclosure.

13. A spring clip device comprising a body having a curved continuous longitudinal sidewall enclosing a longitudinal opening; wherein two parallel longitudinal edges define the sidewall length of said spring clip; thereof said spring clip is configured to circumscribe a known-size frame member of a frame structure with tight fit; and whereby a sheeting is sandwiched between said frame member and said spring clip and secured to said frame structure.

14. A spring clip device as in claim 13, wherein said spring clip further comprises a body having a generally symmetric and similar to a C-shape cross-section, which is designed for a frame member with elongated cross-sectional shape; wherein said body consists of a flat base section connected by two inwardly curved lateral sections on both ends, forming a longitudinal sidewall having a similar to C-shape cross-section and an longitudinal opening; whereof each end of said opening is connected by a protruding lip projecting inwardly towards said flat base section; and wherein the gap between the outmost tip of said protruding lip and the inner surface of said flat base section is slightly shorter than said frame member's outer cross-sectional width.

15. A spring clip device as in claim 13, wherein said spring clip further comprises a body having a generally symmetric and similar to bottle-shape cross-section, which is designed for a frame member with rectangular or square cross-sectional shape; wherein said body consists of a flat base section connected by two inwardly curved lateral sections on both ends, forming a longitudinal sidewall having a similar to bottle body cross-section and a longitudinal opening, thereof each end of said opening is connected by a protruding lip projecting inwardly towards said flat base section; and wherein the gap between the outmost tip of said protruding lip and the inner surface of said flat base section is slightly shorter than said frame member's outer cross-sectional width.

16. A spring clip device as in claim 13, wherein said spring clip further comprises a body having a generally symmetric and similar to V-shape cross-section, which is designed for a frame member with rectangular, or square, or hexagon cross-sectional shape; wherein said body consists of a flat base section connected by two inwardly curved lateral sections on both ends, forming a base with a similar to partial stadium cross-sectional shape; thereof each of said two lateral sections is connected by an inclined flat section projecting upward from said base section and outward from the symmetric center, forming one side of the V-shape; thereof each said inclined flat section is connected by an enclosing flat section erecting inwards to the symmetric center from said inclined flat section, forming a longitudinal sidewall with a similar to V-shape cross-section and a longitudinal opening between the ends of both said enclosing sections; whereof each end of said opening is connected by a protruding lip projecting inwardly towards the opposing said inclined flat section; and wherein the gap between the outmost tip of said protruding lip and the inner surface of the opposing said inclined flat section is slightly shorter than said frame member's outer cross-sectional width.

17. A spring clip device as in claim 13, wherein said spring clip further comprises a body having a generally symmetric and similar to C-shape cross-section, which is designed for a frame member with cylindrical shape; wherein said body consists of a curved base section forming a longitudinal sidewall having a C-shape cross-section and a longitudinal opening; whereof each end of said opening is connected by a protruding lip projecting inwardly towards the center of said curved base section; and wherein the gap between the outmost tip of said protruding lip and the center of said curved base section is slightly shorter than said frame member's outer cross-sectional radius.

18. A clamp device comprising:
a first arm having a longitudinal body comprising a jaw end having a bent longitudinal sidewall with a depressed side and a vaulted side, a pair of protruding hinge seats spaced apart between the longitudinal edges of said longitudinal sidewall and facing similar direction as the depressed side of said jaw end, and a lever section to achieve mechanical advantage; wherein two longitudinal edges define the longitudinal length of said first arm;
a second arm having a longitudinal body sized and shaped to pair with said first arm to form said clamp, which contains a jaw end identical to said jaw end of said first arm, a pair of protruding hinge seats spaced apart between the longitudinal edges and facing similar direction as the depressed side of said jaw end, and a lever section to achieve mechanical advantage; wherein two longitudinal edges define the longitudinal length of said second arm;
a pair of teethed pads having longitudinally vaulted teeth, wherein said pair of teethed pads are made of resilient and elastic material and are sized and bonded to the depressed sides of respective said jaw ends of said first and second arms;
wherein said first arm and said second arm are pivotally interconnected on respective said pair of hinge seats, having respective depressed sides of respective said jaw ends facing each other, and forming a pivot, a pair of levers and a pair of teethed jaws to bite on a frame member;
wherein the distance between the outmost tooth edges of said pair of jaws defines a gap of said clamp; wherein said gap is variable so that said clamp device can accommodate frame members with various sizes and cross-sectional shapes, and used as a universal clamp device;
wherein said pair of teethed pads are deformed when compressing pressure is applied on said pair of jaws from said pair of levers, forming multiple contact areas and increasing friction between said pair of teethed pads and the contact surfaces of said frame member; and
wherein a sheeting is sandwiched between said pair of teethed pads and said frame member, whereby secured to said frame member.

19. A clamp device as in claim 18, wherein said clamp further comprises:
a spring;
a hinge;
a pair of teeth pads;
a first arm comprising a body having a jaw end on one end, connected by a pair of hinge seats in the middle and a lever section on the other end, wherein said pair of hinge seats are spaced apart and disposed along two longitudinal edges of said body, wherein said lever portion is disposed with an obtuse angle relative to the tangent of the portion of sidewall of said jaw end adjacent to said pair of hinge seats;
a second arm comprising a body having a jaw end on one end, a pair of hinge seats in the middle and a lever section on the other end, wherein said pair of hinge seats are spaced apart and offset inwardly from two longitudinal edges of said body to couple with said pair of hinge seats of said first arm to form a pivot, wherein said lever section is disposed with an obtuse angle relative to the tangent of the portion of sidewall of said jaw end adjacent to said pair of hinge seats;
wherein said first arm and said second arm are pivotally interconnected on respective said pair of hinge seats via said hinge and said spring in between, forming a spring clamp with a pair of teethed jaws, a spring pivot and a pair of levers; and
wherein said spring provides compressing force to said pair of jaws from said pair of levers.

20. A clamp device as in claim 18, wherein said spring clamp further comprising:
a first hinge;
a second hinge;
a pair of teethed pads;
a ring bolt having a ring end and a bolt end;
a swivel nut comprising a body having a first hinge end, connected by a nut section having an inner-threaded hole in the middle of said nut section sized to rotatably receive said bolt end of said ring bolt, which is further connected by a second hinge end coaxial to and same size as said first hinge end;
an actuator comprising a longitudinal body having a lever end and a cam end; wherein two longitudinal edges define the length of said actuator; wherein said cam end comprises a pair of cam discs spaced apart along two longitudinal edges, and said lever end bridges said two cam discs longitudinally and further projects away from said cam end transversely; thereof each of said pair of cam discs has an off-center bore coaxial to each other and sized to pivotally receive said first hinge, and together forming a pair of hinge seats; wherein said pair of cam discs contain a curved longitudinal camming surface; thereof said camming surface consists of a first surface having a smaller constant radius curvature, followed by a second surface having a variable radius curvature with gradually increasing radius, followed by a third surface with larger constant radius curvature, whereof the radius is measured transversely from the axis of said bores to said camming surface;
a first arm comprising a body having a jaw end, followed by a lever section consisting of a sidewall having two longitudinal edges offset inwardly from the two longitudinal edges of said first arm, which is disposed with an obtuse angle relative to the tangent of the adjacent portion of sidewall of said jaw end and has a notched cut-out in the middle; thereof the outer surface of said lever section facing similar direction as the vaulted side of said jaw end forms a camming surface; thereof said lever section is further connected by a forked hinge end having a pair of transversely protruding hinge seats spaced apart along the two longitudinal edges of said lever section;
a second arm comprising a body having a jaw end, followed by a lever section consisting of a sidewall disposed with an obtuse angle relative to the tangent of the adjacent portion of sidewall of said jaw end on one end, and a centrally slotted cut-out on the other end, forming two transverse sidewalls spaced apart along the two longitudinal edges of said second arm; thereof each of said two transverse sidewalls contains a bore coaxial to each other and sized to pivotally receive said swivel nut, and together forming a first pair of hinge seats; thereof each of said two traverse sidewalls further extend towards similar direction as the depressed side of said jaw end, forming a hinge end consisting of a second pair of hinge seats;
wherein said swivel nut is pivotally connected to said first pair of hinge seats of said second arm;
wherein said first arm and said second arm are pivotally interconnected on said pair of hinge seats of said first arm and said second pair of hinge seats of said second arm via said second hinge, forming a pair of teethed jaws on one end, a pair of levers in the middle, and a pivot on the other end;
wherein said ring bolt is pivotally connected to said actuator on the ring end via said first hinge, forming a camming pivot; whereof said ring bolt is disposed through said notched cutout of said first arm and rotatably engaged with said swivel nut on said bolt end; wherein said actuator cams on said camming surfaces of said actuator and said lever section of said first arm; and
wherein said ring bolt pairs up with said swivel nut and in conjunction with said actuator to provide the compressing force to said pair of jaws from said pair of levers.

21. A clamp device as in claim 18, wherein said clamp further comprises:
a first hinge;
a second hinge;
a pair of teethed pads;
a wing bolt having a wing end and a bolt end;
a swivel nut comprising a body having a first hinge end, connected by a nut section having an inner-threaded hole in the middle of said nut section sized to rotatably receive said bolt end of said ring bolt, which is further connected by a second hinge end coaxial to and same size as said first hinge end;
a first arm comprising a body having a jaw end, followed by a lever section consisting of a sidewall having two longitudinal edges offset inwardly from the two longitudinal edges of said first arm, which is disposed with an obtuse angle relative to the tangent of the adjacent portion of sidewall of said jaw end and has a notched cut-out in the middle; thereof said lever section is further connected by a forked hinge end having a pair of transversely protruding hinge seats spaced apart along the two longitudinal edges of said lever section;
a second arm comprising a body having a jaw end, followed by a lever section consisting of a sidewall disposed with an obtuse angle relative to the tangent of the adjacent portion of sidewall of said jaw end on one end, and a centrally slotted cut-out on the other end, forming two transverse sidewalls spaced apart along the two longitudinal edges of said second arm; thereof each of said two transverse sidewalls contains a bore coaxial to each other and sized to pivotally receive said swivel nut, and together forming a first pair of hinge seats; thereof each of said two traverse sidewalls further extend towards similar direction as the depressed side of said jaw end, forming a hinge end consisting of a second pair of hinge seats;
wherein said swivel nut is pivotally connected to said first pair of hinge seats of said second arm;
wherein said first arm and said second arm are pivotally interconnected on said pair of hinge seats of said first arm and said second pair of hinge seats of said second arm via said second hinge, forming a pair of teethed jaws on one end, a pair of levers in the middle, and a pivot on the other end;
wherein said wing bolt is disposed through said notched cutout of said first arm and rotatably engaged with said swivel nut on said bolt end; and
wherein said wing bolt pairs up with said swivel nut to provide the compressing force to said pair of jaws from said pair of levers.
